(19) United States
(12) Patent Application Publication
(10) Pub. No.: US 2026/0226897 A1
(43) Pub. Date: Aug. 6, 2026

(54) COMPRESSOR

(71) Applicant: SAMSUNG ELECTRONICS CO., LTD., Suwon-si (KR)

(72) Inventors: Sedong LEE, Suwon-si (KR); Jongwon CHOI, Suwon-si (KR); Wooju JEON, Suwon-si (KR); Jaewoo PARK, Suwon-si (KR); Joonhyung KIM, Suwon-si (KR); Munseong KWON, Suwon-si (KR)

(73) Assignee: SAMSUNG ELECTRONICS CO., LTD., Suwon-si (KR)

(21) Appl. No.: 19/380,229

(22) Filed: Nov. 5, 2025

Related U.S. Application Data
(63) Continuation of application No. PCT/KR2025/016545, filed on Oct. 20, 2025.

(30) Foreign Application Priority Data
Feb. 5, 2025 (KR) 10-2025-0014776

(51) Int. Cl. F04C 18/32; F04C 29/02

(52) U.S. Cl. CPC F04C 18/32; F04C 29/02

(57) ABSTRACT

A compressor includes: a cylinder including a chamber ; a roller in the chamber and configured to compress a refrigerant in the chamber, the roller including: a roller body movable in the chamber along an inner surface of the cylinder, and a vane portion extending from the roller body toward the cylinder and at least partially partitioning the chamber to form an inlet chamber into which the refrigerant is receivable and a compression chamber in which the refrigerant is compressible, the vane portion movable in a radial direction of the roller body based on movement of the roller body; a bushing in the cylinder and rotatable relative to the cylinder, the busing covering at least a portion of the vane portion, and supporting movement of the vane portion along the radial direction; and a bushing cover surrounding the bushing, and rotatable along a rotation direction of the bushing.

### CROSS-REFERENCE TO RELATED APPLICATIONS

This is a continuation application, under 35 U.S.C. §111(a), of International Application No. PCT/KR2025/016545, filed October 20, 2025, which claims priority under 35 U.S.C. §119 to Korean Patent Application No. 10-2025-0014776, filed February 5, 2025, in the Korean Intellectual Property Office, the disclosures of which are incorporated herein in their entireties by reference.

### TECHNICAL FIELD

The present disclosure relates to a compressor including an improved structure.

### BACKGROUND ART

A compressor is a mechanical device that receives power from a power generation device, such as an electric motor or turbine, to compress air, refrigerant, or other working gases to increase a pressure thereof. The compressor is widely used in home appliances such as a refrigerator, an air conditioner, and a clothes dryer, as well as in industries. The types of compressors include a reciprocating compressor, a scroll compressor, and a rotary compressor.

The reciprocating compressor forms a compression chamber, in which a working gas is drawn and discharged, between a piston and a cylinder, to allow the piston to reciprocate linearly in the cylinder so as to compress the working gas.

The scroll compressor forms a compression chamber, in which a working gas is drawn and discharged, between an orbiting scroll and a fixed scroll, to allow the orbiting scroll to orbit with respect to the fixed scroll so as to compress the working gas.

The rotary compressor forms a compression chamber, in which a working gas is drawn and discharged, between a rolling piston that rotates eccentrically and a cylinder, to allow the rolling piston to eccentrically rotate along an inner wall of the cylinder so as to compress the working gas.

### DISCLOSURE

### Technical Problem

The present disclosure is directed to providing a compressor having improved performance and reliability.

Further, the present disclosure is directed to providing a compressor capable of reducing friction loss occurring in a bushing coupled to a vane.

Additional aspects of the disclosure will be set forth in part in the description which follows and, in part, will be obvious from the description, or may be learned by practice of the disclosure.

### Technical Solution

In accordance with the present disclosure a compressor includes: a cylinder including a chamber therein; a roller in the chamber and configured to compress a refrigerant received in the chamber, the roller including: a roller body movable in the chamber along an inner surface of the cylinder, and a vane portion extending from the roller body toward the cylinder and at least partially partitioning the chamber to form an inlet chamber into which the refrigerant is receivable and a compression chamber in which the refrigerant is compressible, the vane portion movable in a radial direction of the roller body based on movement of the roller body; a bushing in the cylinder and rotatable relative to the cylinder, the bushing covering at least a portion of the vane portion, and supporting movement of the vane portion along the radial direction; and a bushing cover surrounding an outer surface of the bushing and rotatable along a rotation direction of the bushing, wherein the roller, the bushing, and the bushing cover are configured such that, with the roller body moved along the inner surface, the bushing supports movement of the vane portion in the radial direction and a size of the inlet chamber increases to move the refrigerant into the chamber and a size of the compression chamber decreases to compress the refrigerant moved into the chamber.

The bushing cover may extend along a circumferential direction of the bushing between the cylinder and the bushing.

The bushing cover may include an opening between a first end of the bushing cover and a second end of the bushing cover opposite the first end along the circumferential direction, and may be configured to allow the vane portion to pass therethrough.

The bushing may be rotatable around a rotation axis parallel to a central axis of the roller body, and the bushing cover may be rotatable around the rotation axis.

Each of the bushing and the bushing cover may configured to rotate as the roller body moves along the inner surface.

With the roller body moved along the inner surface, an angular velocity at which the bushing cover rotates may be less than an angular velocity at which the bushing rotates.

The compressor may further include: a plate on a side of the cylinder to form the chamber together with the cylinder, the plate may include an insertion groove into which at least a portion of the bushing cover may be inserted.

The bushing cover or may be configured to rotate while being inserted into the insertion groove. At least one end of the insertion groove along the circumferential direction of the bushing may be outside of the chamber.

The vane portion may include: a first vane body that protrudes from the roller body in the radial direction and may be covered by the bushing, and a second vane body that may protrude from the first vane body in the radial direction and extends outside of the bushing, the bushing may include a bushing opening that allows the second vane body to pass therethrough, and the bushing cover may include a cover opening that allows the second vane body to pass therethrough.

The cover opening may extend along a first direction in which a rotation axis of the bushing cover extends and a second direction intersecting the first direction, and a length of the cover opening in the second direction may be greater than a thickness of the second vane body in the second direction.

Oil may be receivable between the cylinder and the bushing cover and between the bushing and the bushing cover.

A hardness of the bushing cover may be greater than a hardness of the cylinder and less than a hardness of the bushing.

The bushing cover may further include: a cover body having the cover opening, and a protrusion that may protrude from the cover body in a direction in which a rotation axis of the bushing extends.

The compressor may further include: a plate on a side of the cylinder to form the chamber together with the cylinder, wherein the plate may include an insertion groove into which at least a portion of the protrusion may be inserted.

Another aspect of the present disclosure provides a compressor including: a cylinder in which a cylinder chamber is provided; a roller configured to compress a refrigerant received in the cylinder chamber, the roller including a roller body configured to move along an inner surface of the cylinder in the cylinder chamber, and a vane portion extending from the roller body toward the cylinder to partition the cylinder chamber; a bushing rotatably coupled to the cylinder, provided to allow at least a portion of the vane portion to be inserted thereinto, the bushing including a first cover portion provided to cover one side surface of the vane portion, a second cover portion provided to cover the other side surface opposite to the one side surface of the vane portion, and a connecting portion provided to connect the first cover portion and the second cover portion; and a bushing cover disposed between the cylinder and the bushing and provided to surround an outer surface of each of the first cover portion, the second cover portion, and the connecting portion.

Another aspect of the present disclosure provides a compressor including: a cylinder, a plate provided on one side of the cylinder and forming a cylinder chamber together with the cylinder; a roller configured to compress a refrigerant received in the cylinder chamber, the roller including a roller body configured to move along an inner surface of the cylinder in the cylinder chamber, and a vane portion extending from the roller body toward the cylinder to partition the cylinder chamber; a bushing rotatably coupled to the cylinder and provided to cover at least a portion of the vane portion; and a bushing cover provided to surround an outer surface of the bushing and coupled to each of the cylinder and the plate.

### DESCRIPTION OF DRAWINGS

FIG. 1 is a cross-sectional view of a compressor and an accumulator according to one embodiment.

FIG. 2 is a perspective view illustrating a portion of a configuration of the compressor according to one embodiment.

FIG. 3 is a perspective view illustrating a portion of the configuration of the compressor according to one embodiment.

FIG. 4 is an exploded view illustrating a portion of the configuration of the compressor illustrated in FIG. 2.

FIG. 5 is an exploded view illustrating a portion of the configuration of the compressor illustrated in FIG. 3.

FIG. 6 is a cross-sectional view taken along line A-A' illustrated in FIG. 2.

FIG. 7 is a cross-sectional view taken along line B-B' illustrated in FIG. 2.

FIG. 8 is a perspective view illustrating a portion of the configuration of the compressor according to one embodiment.

FIG. 9 is an exploded view illustrating a portion of the configuration of the compressor illustrated in FIG. 8.

FIG. 10 is a perspective view illustrating a bushing cover according to one embodiment.

FIG. 11 is a perspective view illustrating a portion of the configuration of the compressor according to one embodiment.

FIG. 12 is a perspective view illustrating a state in which a roller, a bushing, and the bushing cover are coupled according to one embodiment.

FIG. 13 is a side view illustrating the state in which the roller, the bushing, and the bushing cover are coupled according to one embodiment.

FIG. 14 is a cross-sectional view taken along line D-D' illustrated in FIG. 11.

FIG. 15 is an enlarged view illustrating a region E illustrated in FIG. 14.

FIG. 16 is a cross-sectional view illustrating a state in which the roller illustrated in FIG. 14 moves along an inner wall of a cylinder.

FIG. 17 is an enlarged view of a region G illustrated in FIG. 16.

FIG. 18 is a view illustrating a state in which a region F illustrated in FIG. 15 and a region H illustrated in FIG. 17 are superimposed.

FIG. 19 is a cross-sectional view illustrating a state in which the roller illustrated in FIG. 16 moves along the inner wall of the cylinder.

FIG. 20 is an enlarged view of a region I illustrated in FIG. 19.

FIG. 21 is a cross-sectional view taken along line C-C' illustrated in FIG. 8.

FIG. 22 is an enlarged view of a region J illustrated in FIG. 21.

FIG. 23 is a perspective view illustrating a state in which a mid-plate, the bushing, and the bushing cover are coupled according to one embodiment.

FIG. 24 is a plan view illustrating the state in which the mid-plate, the bushing, and the bushing cover are coupled according to one embodiment.

FIG. 25 is an enlarged view of a region K illustrated in FIG. 24.

FIG. 26 is a perspective view illustrating a bushing cover according to one embodiment.

FIG. 27 is a perspective view illustrating a state in which a mid-plate, a bushing, and the bushing cover are coupled according to one embodiment.

FIG. 28 is a plan view illustrating the state in which the mid-plate, the bushing, and the bushing cover are coupled according to one embodiment.

FIG. 29 is an enlarged view of a region L illustrated in FIG. 28.

### MODES OF THE INVENTION

The various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of "and / or" includes a plurality of combinations of relevant items or any one item among a plurality of relevant items.

Herein, the term “a first”, “a second”, “the first”, “the second”, etc., may simply be used to distinguish an element from other elements, but is not limited to another aspect (importance or order) of elements.

In the following detailed description, the terms of “front surface”, “rear surface”, “upper surface”, “lower surface”, “side surface”, “left side”, “right side”, “upper portion”, “lower portion” and the like may be defined based on the drawings, but the shape and the location of the element is not limited by the term.

In this disclosure, the terms "including", "having", and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

Hereinafter exemplary embodiments of the present disclosure will be described in detail with reference to the accompanying drawings

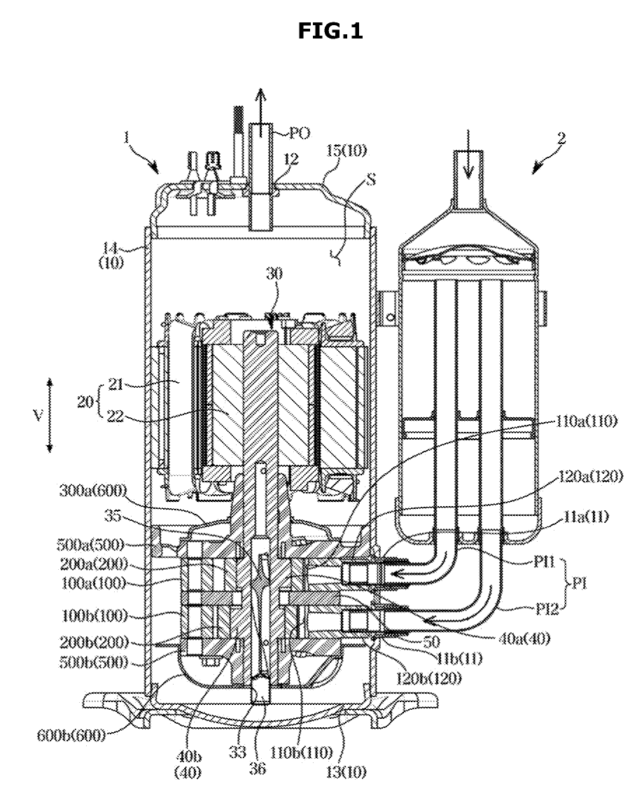

FIG. 1 is a cross-sectional view of a compressor and an accumulator according to one embodiment.

Referring to FIG. 1, a compressor 1 according to one embodiment of the present disclosure may include a compression portion (including components such as a cylinder 100, a roller 200, and the like) configured to compress a refrigerant, a drive motor 20 configured to provide power to the compression portion, and a housing 10 provided to receive the compression portion and the drive motor 20.

The housing 10 may form an exterior of the compressor 1. The housing 10 may form a receiving space S to receive components of the compressor 1. For example, the compression portion, the drive motor 20 and the like may be received in the receiving space S.

The housing 10 may be provided to receive oil. In other words, the housing 10 may be provided to store oil. The oil may reduce friction between various members of the compressor 1. The oil may lubricate the various members of the compressor 1.

The housing 10 may include a refrigerant inlet portion 11, and a refrigerant outlet portion 12. The refrigerant inlet portion 11 may be provided to allow a refrigerant to be introduced from the outside of the housing 10 into the inside of the housing 10. The refrigerant outlet portion 12 may be provided to allow the refrigerant to be discharged from the inside of the housing 10 to the outside of the housing 10.

A plurality of refrigerant inlet portions 11 may be provided. For example, when the compressor 1 includes an upper cylinder 100a, and a lower cylinder 100b, the refrigerant inlet portion 11 may include a first refrigerant inlet portion 11a connected to the upper cylinder 100a, and a second refrigerant inlet portion 11b connected to the lower cylinder 100b.

A compressor inlet pipe PI may be coupled to the refrigerant inlet portion 11 of the housing 10. The compressor inlet pipe PI may be provided to guide a refrigerant that is introduced from the outside of the housing 10 into the inside of the housing 10 through the refrigerant inlet portion 11.

The housing 10 may be connected to an accumulator 2 through the compressor inlet pipe PI. The accumulator 2 may be configured to separate refrigerant liquid from refrigerant gas and supply the refrigerant gas, from which the refrigerant liquid is separated, to the compressor 1. The compressor inlet pipe PI may be provided to guide the refrigerant, which is supplied from the accumulator 2, into the inside of the housing 10.

A plurality of compressor inlet pipes PI may be provided. For example, when the compressor 11 includes the upper cylinder 100a and the lower cylinder 100b, the compressor inlet pipe PI may include an upper cylinder inlet pipe PI1 connected to the upper cylinder 100a, and a lower cylinder inlet pipe PI2 connected to the lower cylinder 100b. The upper cylinder inlet pipe PI1 may be coupled to the first refrigerant inlet portion 11a, and the lower cylinder inlet pipe PI2 may be coupled to the second refrigerant inlet portion 11b.

A compressor outlet pipe PO may be coupled to the refrigerant outlet portion 12 of the housing 10. The compressor outlet pipe PO may be provided to guide a refrigerant that is discharged from the inside of the housing 10 to the outside of the housing 10 through the refrigerant outlet portion 12.

For example, the refrigerant inlet portion 11 may be provided at a lower portion of the housing 10, and the compressor inlet pipe PI may be connected to the lower portion of the housing 10. For example, the refrigerant outlet portion 12 may be provided at an upper portion of the housing 10, and the compressor outlet pipe PO may be connected to the upper portion of the housing 10.

The housing 10 may include a base 13, a side frame 14, and a top cover 15. The base 13 may form a lower exterior of the housing 10. The side frame 14 may form a side wall of the housing 10. The top cover 15 may form an upper exterior of the housing 10. At least some of the base 13, the side frame 14, and the top cover 15 may be detachably coupled to each other. At least some of the base 13, the side frame 14, and the top cover 15 may be formed integrally with each other.

The drive motor 20 may be configured to generate power. Particularly, the drive motor 20 may generate a rotational force. The drive motor 20 may convert electromagnetic force into mechanical rotational force. The drive motor 20 may be disposed above the compression portion.

The drive motor 20 may include a stator 21 fixed to the housing 10, and a rotor 22 rotatable with respect to the stator 21. The stator 21 may include a stator core, and a coil wound around the stator core. The rotor 22 may include a plurality of magnets.

In the drawing, an inner rotor type drive motor 20, in which the rotor 22 is disposed inside the stator 21, is illustrated, but the present disclosure is not limited thereto. The drive motor 20 may also be an outer rotor type in which the rotor 22 is disposed outside the stator 21. As long as the drive motor 20 generates power, there is no limitation on the type of the drive motor 20.

The compressor 1 may include a rotating shaft 30. The rotating shaft 30 may be configured to transmit power generated from the drive motor 20 to the compression portion. The rotating shaft 30 may be provided to connect the drive motor 20 and the compression portion.

The rotating shaft 30 may be connected to the rotor 22. The rotating shaft 30 may be fixed to the rotor 22 and rotate together with the rotor 22.

The rotating shaft 30 may extend along a vertical direction V. For example, the rotating shaft 30 may extend along an up and down direction. The rotating shaft 30 may extend along the gravity direction. The rotating shaft 30 may extend along a height direction of the compressor 1.

The rotating shaft 30 may be provided to penetrate components of the compression portion. For example, the rotating shaft 30 may be provided to penetrate a muffler 600, a cylinder cover 500, the cylinder 100, and the roller 200, which will be described later, in a substantially vertical direction V. For example, the rotating shaft 30 may be provided to penetrate an upper muffler 600a, an upper cylinder cover 500a, the upper cylinder 100a, an upper roller 200a, a mid-plate 50, the lower cylinder 100b, a lower roller 200b, a lower cylinder cover 500b, and a lower muffler 600b in the substantially vertical direction V.

In addition, the rotating shaft 30 may be provided to penetrate a central portion of a cylinder chamber 110 to be described later. In other words, a central axis of the rotating shaft 30 may be the same as a central axis of the cylinder chamber 110 to be described later. For example, the rotating shaft 30 may penetrate a central portion of an upper cylinder chamber 110a and a central portion of a lower cylinder chamber 110b to be described later, respectively.

The compressor 1 may include a cam 40. The cam 40 may be provided on an outer surface of the rotating shaft 30. A central axis of the cam 40 may be eccentric from the central axis of the rotating shaft 30. The cam 40 may be configured to transmit the rotational force of the rotating shaft 30 to the compression portion.

The compressor 1 may include at least one cylinder 100, at least one roller 200, at least one cylinder cover 500, at least one muffler 600, at least one cam 40, a bushing 300 and a bushing cover 400 described later. In the drawing, it is illustrated that two cylinders 100, two rollers 200, two bushings 300, two bushing covers 400, two cylinder covers 500, two mufflers 600, and two cams 40 are provided. However, the present disclosure is not limited thereto. Alternatively, the compressor 1 may include a single cylinder 100, a single roller 200, a single bushing 300, a single bushing cover 400, a single cylinder cover 500, a single muffler 600, and a single cam 40. Alternatively, the compressor 1 may include three or more cylinders 100, three or more rollers 200, three or more bushings 300, three or more bushing covers 400, three or more cylinder covers 500, three or more mufflers 600, and three or more cams 40.

Meanwhile, the terms "upper ~" and "lower ~" may be used to distinguish between the plurality of components included in the compressor 1. A component for which the term "upper ~" is used may be indicated with a drawing symbol “a”, and a component for which the term "lower ~" is used may be indicated with a drawing symbol “b”. For example, when the compressor 1 includes two cylinders 100, a cylinder positioned relatively above among the two cylinders may be referred to as an upper cylinder 100a, and a cylinder positioned relatively below among the two cylinders may be referred to as a lower cylinder 100b. When there is no need to distinguish between the plurality of components included in the compressor 1, the terms "upper ~" and "lower ~" may not be used. For example, a description of the cylinder 100 may be a description common to both the upper cylinder 100a and the lower cylinder 100b. In addition, the above-described contents are applied not only to the cylinder 100, but also applied to the roller 200, the bushing 300, the bushing cover 400, the cylinder cover 500, the muffler 600, and the cam 40.

In other words, a description of the cylinder 100 may be applied to each of the upper cylinder 100a and the lower cylinder 100b. A description of the roller 200 may be applied to each of the upper roller 200a and the lower roller 200b. A description of the bushing 300 may be applied to each of an upper bushing 300a and a lower bushing 300b. A description of the bushing cover 400 may be applied to each of an upper bushing cover 400a and a lower bushing cover 400b. A description of the cylinder cover 500 may be applied to each of the upper cylinder 500a and the lower cylinder 500b. A description of the muffler 600 may be applied to each of the upper muffler 600a and the lower muffler 600b. A description of the cam 40 may be applied to each of an upper cam 40a and a lower cam 40b.

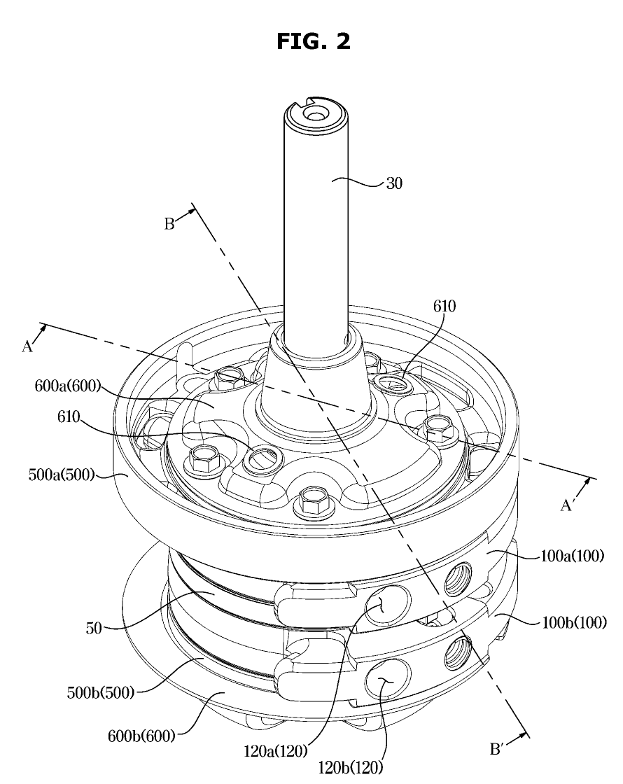

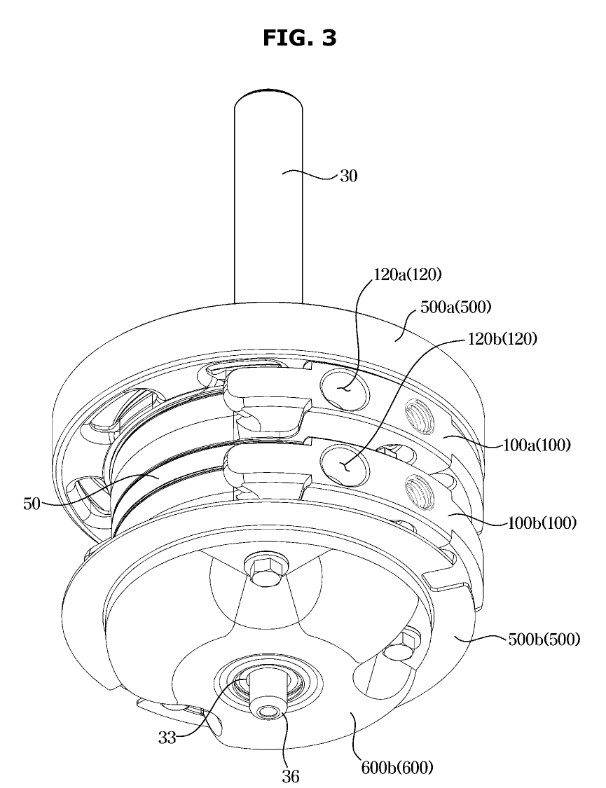

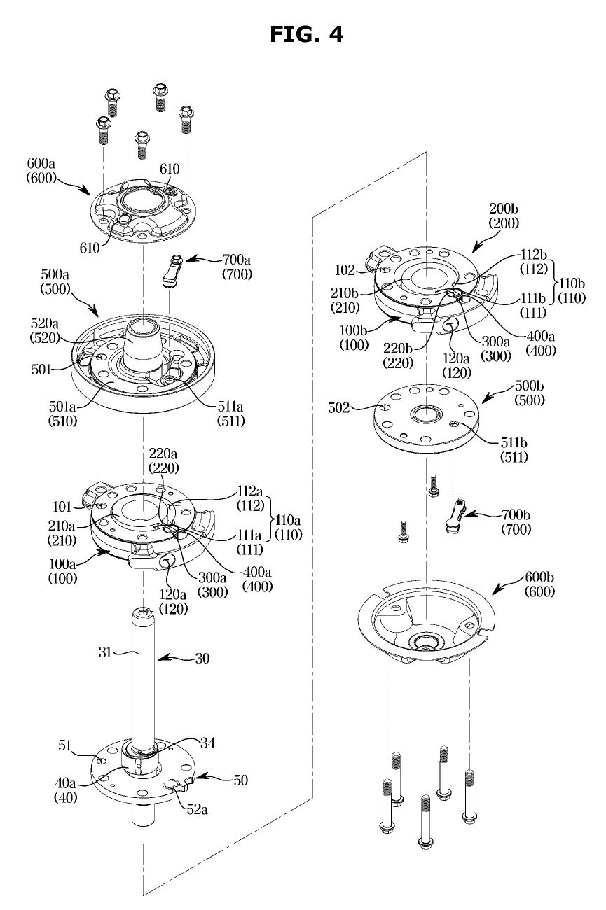

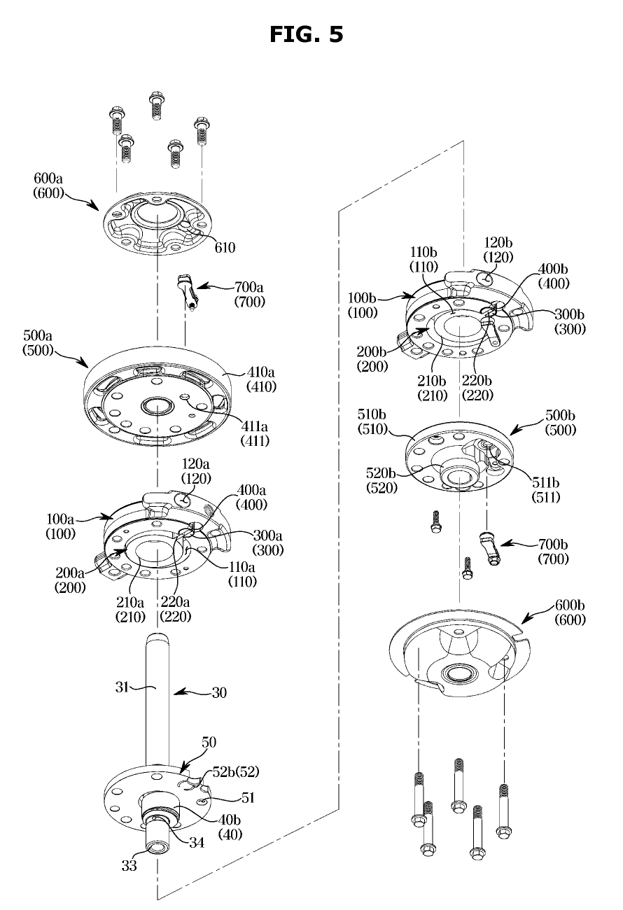

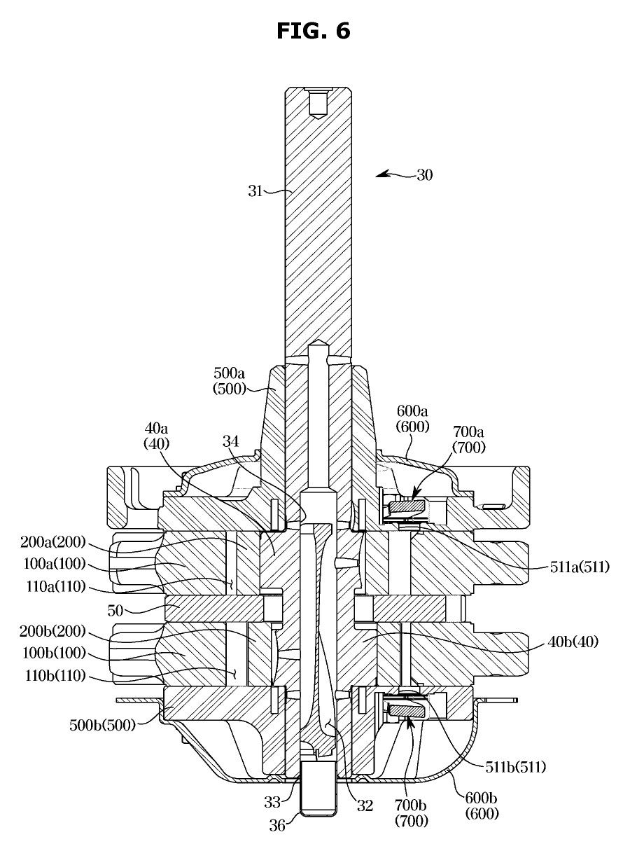

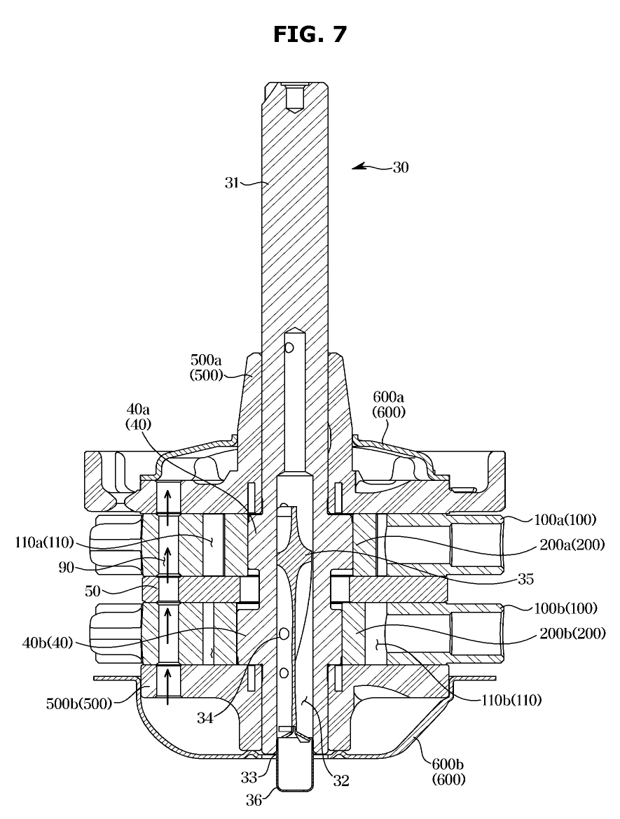

FIG. 2 is a perspective view illustrating a portion of a configuration of the compressor according to one embodiment. FIG. 3 is a perspective view illustrating a portion of the configuration of the compressor according to one embodiment. FIG. 4 is an exploded view illustrating a portion of the configuration of the compressor illustrated in FIG. 2. FIG. 5 is an exploded view illustrating a portion of the configuration of the compressor illustrated in FIG. 3. FIG. 6 is a cross-sectional view taken along line A-A' illustrated in FIG. 2. FIG. 7 is a cross-sectional view taken along line B-B' illustrated in FIG. 2.

Hereinafter a portion of a configuration of the compressor 1 will be described with reference to FIGS. 1 to 7. Particularly, one embodiment, in which two cylinders 100, two rollers 200, two bushings 300, two bushing covers 400, two cylinder covers 500, two mufflers 600, and two cams 40 are provided, will be described. However, as described above, the present disclosure is not limited to the embodiment.

The compressor 1 may include at least one cylinder 100.

The cylinder 100 may include the cylinder chamber 110. The cylinder chamber 110 may be provided inside the cylinder 100. For example, the cylinder 100 may have a substantially ring shape, and the cylinder chamber 110 may be formed in an inner portion of the ring shape of the cylinder 100.

The cylinder chamber 110 may be provided to receive a refrigerant. Particularly, the cylinder chamber 110 may be provided to receive a refrigerant supplied from the accumulator 2. The refrigerant received in the cylinder chamber 110 may be compressed. Particularly, the cylinder chamber 110 may include an inlet chamber 111 into which the refrigerant is introduced, and a compression chamber 112 into which the introduced refrigerant is compressed.

The cylinder 100 may include an inlet hole 120 through which the refrigerant is introduced. The inlet hole 120 may be connected to the refrigerant inlet portion 11 and the compressor inlet pipe PI. That is, the refrigerant supplied to the compressor inlet pipe PI may sequentially pass through the refrigerant inlet portion 11 and the inlet hole 120 and flow into the cylinder chamber 110.

The inlet hole 120 may communicate with the cylinder chamber 110. Particularly, the inlet hole 120 may communicate with the inlet chamber 111 of the cylinder chamber 110.

For example, the compressor 1 may include the upper cylinder 100a and the lower cylinder 100b. The upper cylinder 100a may be positioned above the lower cylinder 100b. In other words, the lower cylinder 100b may be positioned below the upper cylinder 100a.

The upper cylinder 100a may include the upper cylinder chamber 110a. The upper cylinder chamber 110a may include an upper inlet chamber 111a into which a refrigerant is introduced, and an upper compression chamber 112a into which the introduced refrigerant is compressed. For example, the upper cylinder chamber 110a may be a space surrounded by an inner surface of the upper cylinder 100a, the upper cylinder cover 500a, and the mid-plate 50.

The upper cylinder 100a may include an upper inlet hole 120a into which a refrigerant is introduced. The upper inlet hole 120a may be connected to the first refrigerant inlet portion 11a and the upper cylinder inlet pipe PI1. The upper inlet hole 120a may communicate with the upper cylinder chamber 110a. Particularly, the upper inlet hole 120a may communicate with the upper inlet chamber 111a.

The lower cylinder 100b may include the lower cylinder chamber 110b. The lower cylinder chamber 110b may include a lower inlet chamber 111b into which a refrigerant is introduced, and a lower compression chamber 112b into which the introduced refrigerant is compressed. For example, the lower cylinder chamber 110b may be a space surrounded by an inner surface of the lower cylinder 100b, the lower cylinder cover 500b, and the mid-plate 50.

The lower cylinder 100b may include a lower inlet hole 120b through which a refrigerant is introduced. The lower inlet hole 120b may be connected to the second refrigerant inlet portion 11b and the lower cylinder inlet pipe PI2. The lower inlet hole 120b may communicate with the lower cylinder chamber 110b. Particularly, the lower inlet hole 120b may communicate with the lower inlet chamber 111b.

The compressor 1 may include the mid-plate 50. The mid-plate 50 may be provided on one side of the cylinder 100. For example, the mid-plate 50 may be disposed between the upper cylinder 100a and the lower cylinder 100b. The mid-plate 50 may form the cylinder chamber 110 together with the cylinder 100 and the cylinder cover 500.

The mid-plate 50 may be positioned below the upper cylinder 100a to cover a lower side of the upper cylinder chamber 110a. The mid-plate 50 may be positioned above the lower cylinder 100b to cover an upper side of the lower cylinder chamber 110b. The mid-plate 50 may be provided to define the upper cylinder chamber 110a and the lower cylinder chamber 110b.

The mid-plate 50 may be coupled to the upper cylinder 100a and/or the lower cylinder 100b. For example, the mid-plate 50 may be screw-coupled to the upper cylinder 100a and/or the lower cylinder 100b. However, the present disclosure is not limited to the above-described examples, and the mid-plate 50 may be coupled to the upper cylinder 100a and/or the lower cylinder 100b through various known coupling methods.

The compressor 1 may include at least one roller 200. The number of rollers 200 may correspond to the number of cylinders 100.

At least a portion of the roller 200 may be provided in the cylinder chamber 110. The roller 200 may be configured to compress the refrigerant received in the cylinder chamber 110.

The roller 200 may include a roller body 210. The roller body 210 may be disposed inside the cylinder chamber 110.

The roller body 210 may be coupled to the cam 40. Particularly, a space for receiving the cam 40 may be provided on the inside of the roller body 210. For example, the roller body 210 may have a substantially ring shape. With this configuration, the roller body 210 may receive a rotational force from the rotating shaft 30.

As described above, the central axis of the cam 40 may be eccentric from the central axis of the rotating shaft 30. In addition, the central axis of the rotating shaft 30 may be the same as the central axis of the cylinder chamber 110, and thus the central axis of the cam 40 may be eccentric from the central axis of the cylinder chamber 110. With this configuration, as the rotating shaft 30 rotates, the roller body 210 may move along the inner surface of the cylinder 100. Particularly, an outer surface of the roller body 210 may move along the inner surface of the cylinder 100 while coming into contact with the inner surface of the cylinder 100.

The roller body 210 may be configured to compress the refrigerant received in the cylinder chamber 110. Particularly, the roller body 210 may compress the refrigerant received in the cylinder chamber 110 as the roller body 210 moves along the inner surface of the cylinder 100.

The roller 200 may include a vane portion 220. The roller body 210 may be formed integrally with the vane portion 220.

The vane portion 220 may extend from the roller body 210 toward the cylinder 100. With this configuration, the vane portion 220 may partition the cylinder chamber 110. Particularly, the vane portion 220 may partition the cylinder chamber 110 into the inlet chamber 111, into which a refrigerant is introduced, and the compression chamber 112, into which the refrigerant is compressed.

For example, the compressor 1 may include the upper roller 200a and the lower roller 200b. The upper roller 200a may be positioned above the mid-plate 50. The lower roller 200b may be positioned below the mid-plate 50.

At least a portion of the upper roller 200a may be provided in the upper cylinder chamber 110a. The upper roller 200a may be configured to compress the refrigerant received in the upper cylinder chamber 110a.

The upper roller 200a may include an upper roller body 210a. The upper roller body 210a may be provided inside the upper cylinder chamber 110a.

The upper roller body 210a may be coupled to the upper cam 40a. With this configuration, the upper roller body 210a may receive a rotational force from the rotating shaft 30. As the rotating shaft 30 rotates, the upper roller body 210a may move along the inner surface of the upper cylinder 100a.

The upper roller 200a may include an upper vane portion 220a. The upper roller body 210a may be formed integrally with the upper vane portion 220a.

The upper vane portion 220a may extend from the upper roller body 210a toward the upper cylinder 100a. With this configuration, the upper vane portion 220a may partition the upper cylinder chamber 110a. Particularly, the upper vane portion 220a may partition the upper cylinder chamber 110a into the upper inlet chamber 111a, into which a refrigerant is introduced, and the upper compression chamber 112a, into which the refrigerant is compressed.

At least a portion of the lower roller 200b may be provided in the lower cylinder chamber 110b. The lower roller 200b may be configured to compress the refrigerant received in the lower cylinder chamber 110b.

The lower roller 200b may include a lower roller body 210b. The lower roller body 210b may be disposed inside the lower cylinder chamber 110b.

The lower roller body 210b may be coupled to the lower cam 40b. With this configuration, the lower roller body 210b may receive a rotational force from the rotating shaft 30. As the rotating shaft 30 rotates, the lower roller body 210b may move along the inner surface of the lower cylinder 100b.

The lower roller 200b may include a lower vane portion 220b. The lower roller body 210b may be formed integrally with the lower vane portion 220b.

The lower vane portion 220b may extend from the lower roller body 210b toward the lower cylinder 100b. With this configuration, the lower vane portion 220b may partition the lower cylinder chamber 110b. Particularly, the lower vane portion 220b may partition the lower cylinder chamber 110b into the lower inlet chamber 111b, into which a refrigerant is introduced, and the lower compression chamber 112b into which the refrigerant is compressed.

The compressor 1 may include at least one bushing 300. The number of bushings 300 may correspond to the number of rollers 200.

The bushing 300 may be rotatably coupled to the cylinder 100. The bushing 300 may be provided to cover at least a portion of the vane portion 220.

The bushing 300 may guide the movement and/or rotation of the vane portion 220. The bushing 300 may reduce friction loss that may occur between the vane portion 220 and the surrounding components. This will be described in more detail later.

For example, the compressor 1 may include the upper bushing 300a and the lower bushing 300b. The upper bushing 300a may be positioned above the mid-plate 50. The lower bushing 300b may be positioned below the mid-plate 50.

The upper bushing 300a may be rotatably coupled to the upper cylinder 100a. The upper bushing 300a may be provided to cover at least a portion of the upper vane portion 220a.

The lower bushing 300b may be rotatably coupled to the lower cylinder 100b. The lower bushing 300b may be provided to cover at least a portion of the lower vane portion 220b.

The compressor 1 may include at least one bushing cover 400. The number of bushing covers 400 may correspond to the number of bushings 300.

The bushing cover 400 may cover the bushing 300. The bushing cover 400 may be provided to surround an outer surface of the bushing 300. The bushing cover 400 may be disposed between the cylinder 100 and the bushing 300.

For example, the compressor 1 may include the upper bushing cover 400a and the lower bushing cover 400b. The upper bushing cover 400a may be positioned above the mid-plate 50. The lower bushing cover 400b may be positioned below the mid-plate 50.

The upper bushing cover 400a may cover the upper bushing 300a. The upper bushing cover 400a may be provided to surround an outer surface of the upper bushing 300a. The upper bushing cover 400a may be disposed between the upper cylinder 100a and the upper bushing 300a.

The lower bushing cover 400b may cover the lower bushing 300b. The lower bushing cover 400b may be provided to surround an outer surface of the lower bushing 300b. The lower bushing cover 400b may be disposed between the lower cylinder 100b and the lower bushing 300b.

The compressor 1 may include the rotating shaft 30. The rotating shaft 30 may extend along the vertical direction V. The rotating shaft 30 may be provided to penetrate the components of the compression portion.

The rotating shaft 30 may include a shaft body 31. A hollow space may be provided inside the shaft body 31 in which an oil flow path 32 is formed. The oil flow path 32 may extend along a longitudinal direction of the shaft body 31. In other words, the oil flow path 32 may extend along the substantially vertical direction V.

The rotating shaft 30 may include an oil suction hole 33. The oil suction hole 33 may be provided to draw in oil received in the housing 10.

The oil suction hole 33 may be provided at a lower end of the shaft body 31. In other words, the oil suction hole 33 may be provided at one end of the oil flow path 32. The oil suction hole 33 may be opened toward a bottom of the housing 10.

For example, in order to draw in oil received in the housing 10, the rotating shaft 30 may include a paddle 35 disposed inside the shaft body 31, and a pickup member 36 disposed in the oil suction hole 33. However, the present disclosure is not limited to the above-described example, and the rotating shaft 30 may draw in oil through various known methods.

The rotating shaft 30 may include an oil discharge hole 34. The oil discharge hole 34 may be provided to discharge oil flowing along the oil flow path 32.

The oil discharge hole 34 may allow the oil flow path 32 to communicate with an outer surface of the shaft body 31. Oil discharged through the oil discharge hole 34 may flow between various components of the compression portion.

A plurality of oil discharge holes 34 may be provided. The plurality of oil discharge holes 34 may be spaced apart from each other along a longitudinal direction of the oil flow path 32. For example, the plurality of oil discharge holes 34 may be spaced apart from each other along the substantially vertical direction V. However, the present disclosure is not limited thereto. According to embodiments, the rotating shaft 30 may include only one oil discharge hole 34.

The compressor 1 may include at least one cam 40. The number of cams 40 may correspond to the number of cylinders 100. The number of cams 40 may correspond to the number of rollers 200.

The cam 40 may be provided on the outer surface of the rotating shaft 30. The central axis of the cam 40 may be eccentric from the central axis of the rotating shaft 30.

The cam 40 may be coupled to the roller body 210. For example, most of an outer surface of the cam 40 may come into contact with most of an inner surface of the roller body 210. As the rotating shaft 30 and the cam 40 rotate, the roller body 210 may move along the inner surface of the cylinder 100.

In the above, the cam 40 is described as a separate component from the rotating shaft 30, but the cam 40 may also be provided as a component of the rotating shaft 30. That is, the rotating shaft 30 may include the cam 40.

For example, the compressor 1 may include the upper cam 40a and the lower cam 40b. The upper cam 40a may be positioned above the mid-plate 50. The lower cam 40b may be positioned below the mid-plate 50.

The upper cam 40a may be provided on the outer surface of the rotating shaft 30. A central axis of the upper cam 40a may be eccentric from the central axis of the rotating shaft 30.

The upper cam 40a may be coupled to the upper roller body 210a. For example, most of an outer surface of the upper cam 40a may come into contact with most of an inner surface of the upper roller body 210a. As the rotating shaft 30 and the upper cam 40a rotate, the upper roller body 210a may move along the inner surface of the upper cylinder 100a.

The lower cam 40b may be provided on the outer surface of the rotating shaft 30. A central axis of the lower cam 40b may be eccentric from the central axis of the rotating shaft 30.

The lower cam 40b may be coupled to the lower roller body 210b. For example, most of an outer surface of the lower cam 40b may come into contact with most of an inner surface of the lower roller body 210b. As the rotating shaft 30 and the lower cam 40b rotate, the lower roller body 210b may move along the inner surface of the lower cylinder 100b.

The upper cam 40a and the lower cam 40b may be eccentric in opposite directions with respect to the central axis of the rotating shaft 30. Accordingly, a phase when the refrigerant in the upper cylinder chamber 110a is compressed by the upper roller 200a and a phase when the refrigerant in the lower cylinder chamber 110b is compressed by the lower roller 200b may be opposite to each other.

The compressor 1 may include at least one cylinder cover 500. The number of cylinder covers 500 may correspond to the number of cylinders 100.

The cylinder cover 500 may be provided on one side of the cylinder 100. The cylinder cover 500 may be provided to cover at least a portion of the cylinder chamber 110. The cylinder cover 500 may form the cylinder chamber 110 together with the cylinder 100 and the mid-plate 50.

The cylinder cover 500 may include a cover body 510. The cover body 510 may be coupled to the cylinder 100.

The cover body 510 may include a connecting hole 511. The connecting hole 511 may connect the cylinder chamber 110 and an inside of the muffler 600 to be described later. The refrigerant compressed in the cylinder chamber 110 may flow into the muffler 600 through the connecting hole 511.

The cylinder cover 500 may include a support portion 520. The support portion 520 may be provided to support the rotating shaft 30. The support portion 520 may extend from the cover body 510. For example, the support portion 520 may be provided to surround a portion of the outer surface of the rotating shaft 30. For example, the support portion 520 may function as a bearing that rotatably supports the rotating shaft 30.

For example, the compressor 1 may include the upper cylinder cover 500a, and the lower cylinder cover 500b. The upper cylinder cover 500a may be positioned above the upper cylinder 100a and the upper roller 200a. The lower cylinder cover 500b may be positioned below the lower cylinder 100b and the lower roller 200b.

The upper cylinder cover 500a may be provided on an upper side of the upper cylinder 100a. The upper cylinder cover 500a may be provided to cover the upper side of the upper cylinder chamber 110a. The upper cylinder cover 500a may form the upper cylinder chamber 110a together with the upper cylinder 100a and the mid-plate 50.

The upper cylinder cover 500a may include an upper cover body 510a. The upper cover body 510a may be coupled to the upper cylinder 100a.

The upper cover body 510a may include an upper connecting hole 511a. The upper connecting hole 511a may connect the upper cylinder chamber 110a and an inside of the upper muffler 600a to be described later. The refrigerant compressed in the upper cylinder chamber 110a may flow to the upper muffler 600a through the upper connecting hole 511a.

The upper cylinder cover 500a may include an upper support portion 520a. The upper support portion 520a may be provided to support the rotating shaft 30. The upper support portion 520a may extend upward from the upper cover body 510a.

The lower cylinder cover 500b may be provided on a lower side of the lower cylinder 100b. The lower cylinder cover 500b may be provided to cover the lower side of the lower cylinder chamber 110b. The lower cylinder cover 500b may form the lower cylinder chamber 110b together with the lower cylinder 100b and the mid-plate 50.

The lower cylinder cover 500b may include a lower cover body 510b. The lower cover body 510b may be coupled to the lower cylinder 100b.

The lower cover body 510b may include a lower connecting hole 511b. The lower connecting hole 511b may connect the lower cylinder chamber 110b and an inside of the lower muffler 600b to be described later. The refrigerant compressed in the lower cylinder chamber 110b may flow to the lower muffler 600b through the lower connecting hole 511b.

The lower cylinder cover 500b may include a lower support portion 520b. The lower support portion 520b may be provided to support the rotating shaft 30. The lower support portion 520b may extend downward from the lower cover body 510b.

The compressor 1 may include at least one valve 700. For example, the number of valves 700 may correspond to the number of cylinders 100.

The valve 700 may be configured to open and close the connecting hole 511 of the cylinder cover 500. The valve 700 may be configured to allow or block the flow of refrigerant. Particularly, the valve 700 may allow the flow of refrigerant based on a pressure of the refrigerant being greater than or equal to a predetermined level and may block the flow of refrigerant based on the pressure of the refrigerant being less than the predetermined level.

For example, the compressor 1 may include an upper valve 700a and a lower valve 700b. The upper valve 700a may be positioned above the upper cylinder cover 500a. The lower valve 700b may be positioned below the lower cylinder cover 500b.

The upper valve 700a may be configured to open and close the upper connecting hole 511a of the upper cylinder cover 500a. The upper valve 700a may open the upper connecting hole 511a based on the pressure of the refrigerant within the upper cylinder chamber 110a being greater than or equal to the predetermined level. The upper valve 700a may close the upper connecting hole 511a based on the pressure of the refrigerant within the upper cylinder chamber 110a being less than the predetermined level.

The lower valve 700b may be configured to open and close the lower connecting hole 511b of the lower cylinder cover 500b. The lower valve 700b may open the lower connecting hole 511b based on the pressure of the refrigerant within the lower cylinder chamber 110b being greater than or equal to the predetermined level. The lower valve 700b may close the lower connecting hole 511b based on the pressure of the refrigerant within the lower cylinder chamber 110b being less than the predetermined level.

The compressor 1 may include at least one muffler 600. The number of mufflers 600 may correspond to the number of cylinders 100. The number of mufflers 600 may correspond to the number of cylinder covers 500.

The muffler 600 may cover at least a portion of the cylinder cover 500. The muffler 600 may be coupled to the cylinder cover 500 and/or the cylinder 100.

The muffler 600 may be configured to reduce noise generated when the refrigerant compressed in the cylinder chamber 110 passes through the cylinder 100. The muffler 600 may be configured to receive the refrigerant discharged from the cylinder cover 500.

For example, the compressor 1 may include the upper muffler 600a and the lower muffler 600b. The upper muffler 600a may be positioned above the upper cylinder cover 500a. The lower muffler 600b may be positioned below the lower cylinder cover 500b.

The upper muffler 600a may cover the upper cylinder cover 500a. The upper muffler 600a may be coupled to the upper cylinder cover 500a and/or the upper cylinder 100a.

The upper muffler 600a may reduce noise generated when the refrigerant compressed in the upper cylinder chamber 110a passes through the upper cylinder 100a. The upper muffler 600a may be configured to receive the refrigerant discharged from the upper cylinder cover 500a.

The upper muffler 600a may include a discharge hole 610 for discharging a refrigerant. The refrigerant within the upper muffler 600a may flow out of the compression portion through the discharge hole 610. In addition, the refrigerant within the lower muffler 600b may also flow into the upper muffler 600a and then flow out of the compression portion through the discharge hole 610. This will be described in detail later.

The lower muffler 600b may cover the lower cylinder cover 500b. The lower muffler 600b may be coupled to the lower cylinder cover 500b and/or the lower cylinder 100b.

The lower muffler 600b may reduce noise generated when the refrigerant compressed in the lower cylinder chamber 110b passes through the lower cylinder 100b. The lower muffler 600b may be configured to receive the refrigerant flowing out from the lower cylinder cover 500b.

Hereinafter an example of the flow of refrigerant will be described with reference to FIGS. 6 and 7. In FIGS. 6 and 7, the flow of refrigerant is indicated by dashed arrows.

The refrigerant may be supplied from the accumulator 2 (refer to FIG. 1) to the compression portion. The refrigerant supplied to the compression portion may be introduced into the upper cylinder chamber 110a through the first refrigerant inlet portion 11a (refer to FIG. 1) and the upper inlet hole 120a (refer to FIG. 2). The upper roller 200a may compress the refrigerant in the upper cylinder chamber 110a. When the pressure of the compressed refrigerant is greater than or equal to the predetermined level, the upper valve 700a may open the upper connecting hole 511a. The compressed refrigerant may be introduced into the upper muffler 600a through the opened upper connecting hole 511a.

The refrigerant introduced into the upper muffler 600a may be discharged from the compression portion through the discharge hole 610 (refer to FIG. 2) of the upper muffler 600a.

The refrigerant may be supplied from the accumulator 2 (refer to FIG. 1) to the compression portion. The refrigerant supplied to the compression portion may be introduced into the lower cylinder chamber 110b through the second refrigerant inlet portion 11b (refer to FIG. 1) and the lower inlet hole 120b (refer to FIG. 2). The lower roller 200b may compress the refrigerant in the lower cylinder chamber 110b. When the pressure of the compressed refrigerant is greater than or equal to the predetermined level, the lower valve 700b may open the lower connecting hole 511b. The compressed refrigerant may be introduced into the lower muffler 600b through the opened lower connecting hole 511b.

The refrigerant in the lower muffler 600b may flow into the upper muffler 600a along a connecting flow path 90. The connecting flow path 90 may be formed by overlapping a hole 502 formed in the lower cylinder cover 500b, a hole 102 formed in the lower cylinder 100b, a hole 51 formed in the mid-plate 50, a hole 101 formed in the upper cylinder 100a, and a hole 501 formed in the upper cylinder cover 500a (refer to FIG. 4). The refrigerant introduced into the upper muffler 600a through the connecting flow path 90 may be discharged through the discharge hole 610 (refer to FIG. 2) of the upper muffler 600a.

Hereinafter the bushing 300, the bushing cover 400, and the surrounding components will be described in more detail. As described above, a description of the bushing 300 may be applied to each of the upper bushing 300a and the lower bushing 300b, and a description of the bushing cover 400 may be applied to each of the upper bushing cover 400a and the lower bushing cover 500b.

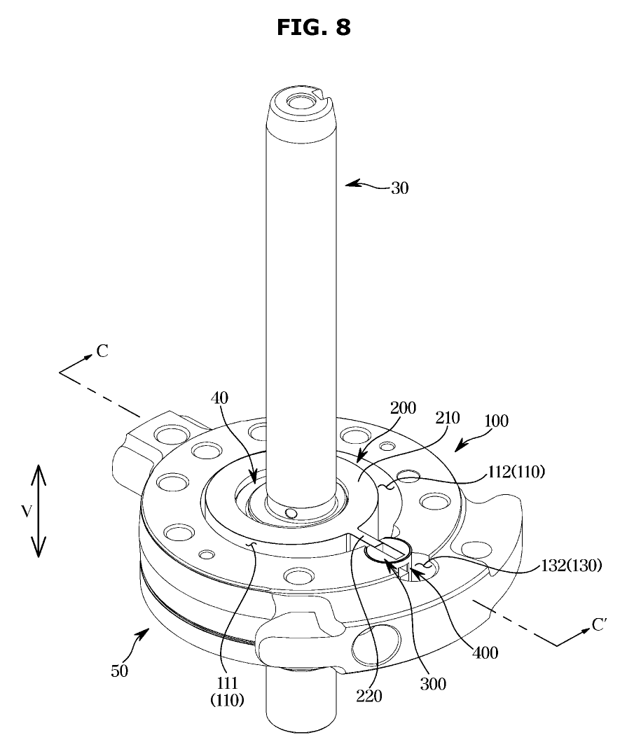

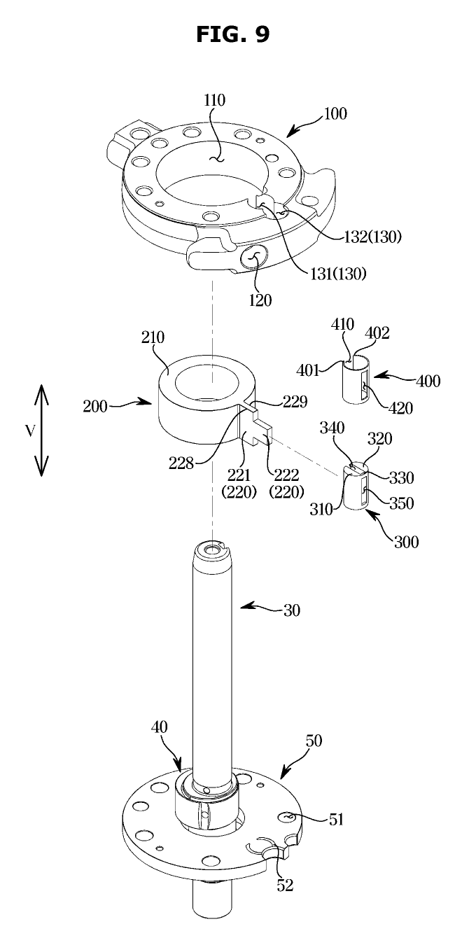

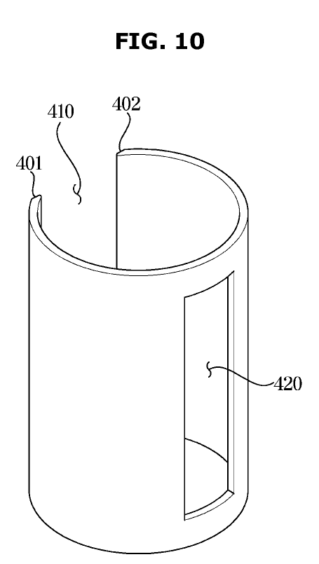

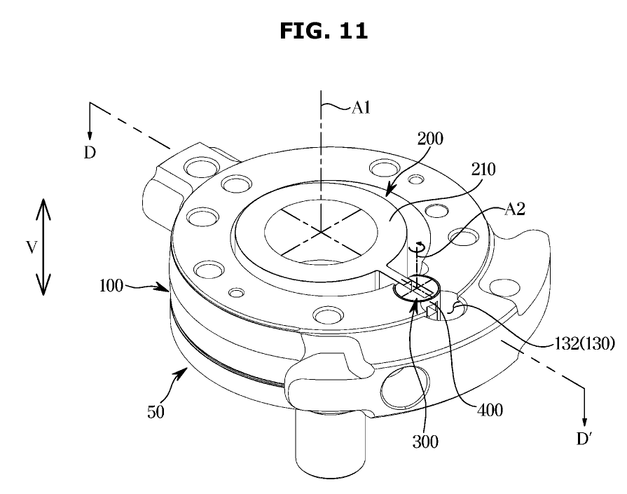

FIG. 8 is a perspective view illustrating a portion of the configuration of the compressor according to one embodiment. FIG. 9 is an exploded view illustrating a portion of the configuration of the compressor illustrated in FIG. 8. FIG. 10 is a perspective view illustrating a bushing cover according to one embodiment. FIG. 11 is a perspective view illustrating a portion of the configuration of the compressor according to one embodiment.

Referring to FIGS. 8 to 11, the compressor 1 may include the rotating shaft 30 and the cam 40. The rotating shaft 30 may extend along the vertical direction V, and the cam 40 may be provided on the outer surface of the rotating shaft 30. Power generated from the drive motor 20 (refer to FIG. 1) may be transmitted to the compression portion through the rotating shaft 30 and the cam 40.

The compressor 1 may include the cylinder 100 and the mid-plate 50. The cylinder chamber 110 in which a refrigerant is received may be provided inside the cylinder 100. The mid-plate 50 may form the cylinder chamber 110 together with the cylinder 100. The cylinder 100 and the mid-plate 50 may be coupled to each other.

The rotating shaft 30 may penetrate the cylinder 100 and the mid-plate 50. At least a portion of the rotating shaft 30 and the cam 40 may be provided within the cylinder chamber 110.

The cylinder 100 may include a cylinder groove 130. The cylinder groove 130 may be formed by being recessed on the inner surface of the cylinder 100. The cylinder groove 130 may be provided to receive at least a portion of the vane portion 220, the bushing 300, and the bushing cover 400.

Particularly, the cylinder groove 130 may form a bushing receiving space 131 for receiving the bushing 300 and the bushing cover 400, and a vane receiving space 132 for receiving at least a portion of the vane portion 220. The bushing receiving space 131 may be provided on the inner side of the vane receiving space 132. Each of the bushing receiving space 131 and the vane receiving space 132 may be formed in a substantially cylindrical shape.

The mid-plate 50 may include a cover insertion groove 52. At least a portion of the bushing cover 400 may be inserted into the cover insertion groove 52. This will be described in more detail later.

The compressor 1 may include the roller 200. The roller 200 may include the roller body 210 and the vane portion 220.

The roller body 210 may be coupled to the cam 40 inside the cylinder chamber 110. With this configuration, the roller body 210 may receive a rotational force from the rotating shaft 30. In addition, the central axis of the cam 40 may be eccentric from the central axis of the cylinder chamber 110, and thus the roller body 210 may move along the inner surface of the cylinder 100 as the rotating shaft 30 rotates. Particularly, the outer surface of the roller body 210 may move along the inner surface of the cylinder 100 while coming into contact with the inner surface of the cylinder 100.

The vane portion 220 may extend from the roller body 210 toward the cylinder 100. With this configuration, the vane portion 220 may partition the cylinder chamber 110. Particularly, the vane portion 220 may partition the cylinder chamber 110 into the inlet chamber 111, into which a refrigerant is introduced, and the compression chamber 112 into which the refrigerant is compressed.

As the roller body 210 moves along the inner surface of the cylinder 100, the vane portion 220 may move and/or rotate with respect to the cylinder 100. For example, the vane portion 220 may move along a radial direction of the roller body 210. For example, the vane portion 220 may rotate along a circumferential direction of the roller body 210 with respect to the cylinder 100. For example, the vane portion 220 may move with respect to the cylinder 100 and rotate with respect to the cylinder 100 at the same time.

The vane portion 220 may include a first vane body 221, and a second vane body 222. The first vane body 221 may protrude from the roller body 210 in the radial direction of the roller body 210. The second vane body 222 may protrude from the first vane body 221 in the radial direction of the roller body 210. Particularly, the second vane body 222 may protrude from one end, which is in the radial direction of the roller body 210, of the first vane body 221 in the radial direction of the roller body 210.

A length, in which the first vane body 221 extends in the vertical direction V, may be greater than a length in which the second vane body 222 extends in the vertical direction V. That is, the first vane body 221 and the second vane body 222 may be provided with a stepped portion.

The compressor 1 may include the bushing 300. The bushing 300 may be coupled to the cylinder 100. Particularly, the bushing 300 may be received in the bushing receiving space 131 of the cylinder 100. The bushing 300 may be coupled to the vane portion 220.

The bushing 300 may guide the movement of the vane portion 220. In other words, the bushing 300 may movably support the vane portion 220. Particularly, the bushing 300 may support the vane portion 220 to move along the radial direction of the roller body 210.

The bushing 300 may be rotatably coupled to the cylinder 100. That is, the bushing 300 may be configured to be rotatable with respect to the cylinder 100. Particularly, the bushing 300 may be configured to rotate about a rotation axis A2 that is provided parallel to a central axis A1 of the roller body 210 (refer to FIG. 11). For example, the bushing 300 may be configured to rotate about the rotation axis A2 that extends in the vertical direction V.

The bushing 300 may guide the rotation of the vane portion 220. The bushing 300 may rotate with respect to the cylinder 100 together with the vane portion 220. In addition, the vane portion 220 may be configured to rotate as the roller body 210 moves along the inner wall of the cylinder 100. Accordingly, the bushing 300 may also be configured to rotate as the roller body 210 moves along the inner wall of the cylinder 100.

According to the present disclosure, the bushing 300 may guide the movement and/or rotation of the vane portion 220. With this configuration, the bushing 300 may facilitate the movement and/or rotation of the roller 200. Accordingly, the bushing 300 may reduce friction loss that may occur between the vane portion 220 and surrounding components (the cylinder 100, the mid-plate 50, the cylinder cover 500, and the like).

The bushing 300 may be provided to cover at least a portion of the vane portion 220. Particularly, the bushing 300 may include a first cover portion 310 provided to cover one side surface 228 of the vane portion 220, a second cover portion 320 provided to cover the other side surface 229 provided on the opposite side of the one side surface 228 of the vane portion 220, and a connecting portion 330 provided to connect the first cover portion 310 and the second cover portion 320. That is, the first cover portion 310 provided to cover the one side surface 228 of the vane portion 220 and the second cover portion 320 provided to cover the other side surface of the vane portion 220 may be integrally formed by the connecting portion 330.

The bushing 300 may be provided to allow at least a portion of the vane portion 220 to be inserted therein. Particularly, the bushing 300 may include a bushing groove 340 provided to allow at least a portion of the vane portion 220 to be inserted therein. The bushing groove 340 may be formed by the first cover portion 310, the second cover portion 320, and the connecting portion 330.

For example, the bushing 300 may be provided to cover the first vane body 221 of the vane portion 220. That is, the bushing groove 340 may be provided to allow the first vane body 221 to be inserted thereinto. The bushing groove 340 may be formed in a shape corresponding to the first vane body 221. As the roller body 210 moves along the inner surface of the cylinder 100, the entire portion of the first vane body 221 may be inserted into the bushing groove 340, or only a portion of the first vane body 221 may be inserted into the bushing groove 340.

The bushing 300 may be provided to allow the vane portion 220 to pass therethrough. Particularly, the bushing 300 may include a bushing opening 350 provided to allow one end of the vane portion 220 to pass therethrough.

The bushing opening 350 may be connected to the bushing groove 340. Particularly, the bushing opening 350 may be formed by being opened in the connecting portion 330. With this configuration, at least a portion of the vane portion 220 may sequentially pass through the bushing groove 340 and the bushing opening 350 to penetrate the bushing 300.

The bushing opening 350 may be provided on the opposite side of an entrance of the bushing groove 340. Particularly, the entrance of the bushing groove 340 may face the cylinder chamber 110, and the bushing opening 350 may face the vane receiving space 132.

For example, the bushing opening 350 may be provided to allow the second vane body 222 to pass therethrough. When the roller body 210 moves along the inner surface of the cylinder 100, the second vane body 222 may move while maintaining a state of passing through the bushing opening 350. Accordingly, at least a portion of the second vane body 222 may be provided on the outer side of the bushing 300. In other words, at least a portion of the second vane body 222 may be provided in the vane receiving space 132.

The compressor 1 may include the bushing cover 400. The bushing cover 400 may cover the bushing 300. The bushing cover 400 may be a floating bushing 400 and may be referred to as a floating bushing 400.

The bushing cover 400 may be coupled to the cylinder 100. Particularly, the bushing cover 400 may be received in the bushing receiving space 131 of the cylinder 100. The bushing cover 400 may be provided on the outside of the bushing 300. In other words, the bushing 300 may be provided on the inside of the bushing cover 400.

The bushing cover 400 may be coupled to the mid-plate 50. Particularly, at least a portion of the bushing cover 400 may be inserted into the cover insertion groove 52 of the mid-plate 50. This will be described in more detail later.

The bushing cover 400 may be provided to surround the outer surface of the bushing 300. Particularly, the bushing cover 400 may be provided to surround the outer surface of each of the first cover portion 310, the second cover portion 320, and the connecting portion 330 of the bushing 300.

The bushing cover 400 may be disposed between the cylinder 100 and the bushing 300. Particularly, the bushing cover 400 may extend along a circumferential direction of the bushing 300 between the cylinder 100 and the bushing 300. With this configuration, the outer surface of the bushing 300 may come into contact with the inner surface of the bushing cover 400, and the outer surface of the bushing cover 400 may come into contact with the cylinder 100.

The bushing cover 400 may include an opening 410. The opening 410 may be formed between one end 401 of the bushing cover 400 along the circumferential direction of the bushing 300 and the other end 402 of the bushing cover 400 provided on the opposite side of the one end 401 of the bushing cover 400. The opening 410 may be provided to allow the vane portion 220 to pass therethrough.

The opening 410 may be provided at a position corresponding to the entrance of the bushing groove 340. Accordingly, at least a portion of the vane portion 220 may be inserted into the bushing groove 340 by passing through the opening 410.

The bushing cover 400 may be provided to allow the vane portion 220 to pass therethrough. Particularly, the bushing cover 400 may include a cover opening 420 through which one end of the vane portion 220 passes.

The cover opening 420 may be formed at a position corresponding to the bushing opening 350. With this configuration, at least a portion of the vane portion 220 may sequentially pass through the opening 410, the bushing groove 340, the bushing opening 350, and the cover opening 420 to penetrate the bushing 300.

The cover opening 420 may be provided on the opposite side of the opening 410. Particularly, the opening 410 may face the cylinder chamber 110, and the cover opening 420 may face the vane receiving space 132.

For example, the cover opening 420 may be provided to allow the second vane body 222 to pass therethrough. When the roller body 210 moves along the inner surface of the cylinder 100, the second vane body 222 may move while maintaining a state of passing through the cover opening 420. Accordingly, at least a portion of the second vane body 222 may be provided on the outer side of the bushing cover 400. In other words, at least a portion of the second vane body 222 may be provided in the vane receiving space 132.

The bushing cover 400 may be rotatably coupled to the cylinder 100 and the mid-plate 50. The bushing cover 400 may be configured to be rotatable between the cylinder 100 and the bushing 300.

The bushing cover 400 may be configured to be rotatable along the rotation direction of the bushing 300. That is, the bushing cover 400 may be configured to rotate around the same rotation axis A2 as the bushing 300 (refer to FIG. 11). Particularly, the bushing cover 400 may be configured to rotate around the rotation axis A2 that is provided parallel to the central axis A1 of the roller body 210. For example, the bushing cover 400 may be configured to rotate around the rotation axis A2 that extends in the vertical direction V.

The bushing cover 400 may be configured to rotate as the bushing 300 rotates. Particularly, the bushing cover 400 and the bushing 300 may be arranged to be in surface contact with each other, and thus the bushing 300 may induce rotation of the bushing cover 400 by the rotation of the bushing 300. In addition, the bushing 300 may be configured to rotate as the roller body 210 moves along the inner wall of the cylinder 100. Accordingly, the bushing cover 400 may be configured to rotate as the roller body 210 moves along the inner wall of the cylinder 100.

An angular velocity of the bushing cover 400 may be less than an angular velocity of the bushing 300. Particularly, the angular velocity at which the bushing cover 400 rotates as the roller body 210 moves along the inner wall of the cylinder 100 may be less than the angular velocity at which the bushing 300 rotates as the roller body 210 moves along the inner wall of the cylinder 100.

In general, friction loss that occurs as the bushing 300 rotates may be proportional to the angular velocity of the bushing 300 and a diameter of the bushing 300. In this case, the angular velocity of the bushing 300 may be a relative velocity with respect to a component that comes into contact with the outer surface of the bushing 300.

According to the present disclosure, the bushing cover 400 may be provided to surround the outer surface of the bushing 300 and may rotate at an angular velocity slower than the bushing 300 along the rotation direction of the bushing 300. Therefore, the angular velocity of the bushing 300 with respect to the bushing cover 400 may be less than the angular velocity of the bushing 300 with respect to the cylinder 100. As described above, the friction loss generated as the bushing 300 rotates may be proportional to the angular velocity of the bushing 300. Accordingly, the friction loss generated by the bushing 300 may be further reduced.

In addition, as the bushing 300 and the bushing cover 400 are arranged together in the bushing receiving space 131 in which the bushing 300 is received, a size of the bushing 300 may be formed smaller. In other words, as the bushing 300 and the bushing cover 400 are arranged together in the bushing receiving space 131, the diameter of the bushing 300 may be formed shorter. As described above, the friction loss generated as the bushing 300 rotates may be proportional to the diameter of the bushing 300. Accordingly, the friction loss generated by the bushing 300 may be further reduced.

That is, by placing the bushing cover 400 between the cylinder 100 and the bushing 300, the friction loss that occurs as the bushing 300 rotates may be further reduced. Accordingly, compression efficiency of the compression portion may be improved, and a failure rate of the compression portion may be reduced. In other words, compression efficiency of the compressor 1 may be improved, and a failure rate of the compressor 1 may be reduced. That is, the performance and reliability of the compressor 1 may be further improved.

Oil may be disposed between the cylinder 100 and the bushing cover 400 and between the bushing 300 and the bushing cover 400. Particularly, oil may be received within the housing 10 (refer to FIG. 1), and the oil may be supplied between the cylinder 100 and the bushing cover 400 and between the bushing 300 and the bushing cover 400 through the oil flow path 32 (refer to FIGS. 6 and 7). The oil may reduce friction between the cylinder 100 and the bushing cover 400 and between the bushing 300 and the bushing cover 400. Accordingly, friction loss occurring as the bushing 300 and the bushing cover 400 rotate may be further reduced.

Oil may be disposed between the mid-plate 50 and the bushing 300, between the mid-plate 50 and the bushing cover 400, between the cylinder cover 500 and the bushing 300, and between the cylinder cover 500 and the bushing cover 400. The oil may reduce friction between the mid-plate 50 and the bushing 300, between the mid-plate 50 and the bushing cover 400, between the cylinder cover 500 and the bushing 300, and between the cylinder cover 500 and the bushing cover 400. Accordingly, friction loss occurring as the bushing 300 and the bushing cover 400 rotate may be further reduced.

A hardness of the bushing cover 400 may be greater than a hardness of the cylinder 100 and less than a hardness of the bushing 300. That is, the bushing cover 400 may have a greater hardness than the cylinder 100, and the bushing 300 may have a greater hardness than the bushing cover 400. As described above, the bushing cover 400 generates friction loss by rotating relatively slowly, and the bushing 300 generates friction loss by rotating relatively quickly. Therefore, a total amount of friction loss generated by each component may be further reduced due to the difference in hardness as described above.

The bushing cover 400 may include a material with a relatively low coefficient of friction. With this configuration, the bushing cover 400 may rotate more smoothly between the cylinder 100 and the bushing 300. Accordingly, friction loss occurring as the bushing 300 and the bushing cover 400 rotate may be further reduced.

The bushing cover 400 may include a material having relatively low thermal conductivity. In other words, the bushing cover 400 may include a material having relatively high thermal insulation performance. For example, the bushing cover 400 may include a Polyether ether ketone (Peek) material.

As the bushing 300 and the bushing cover 400 rotate, frictional heat may be generated among the cylinder 100, the bushing 300, and the bushing cover 400. When the frictional heat is transferred to the inside of the cylinder chamber 110, a temperature of the refrigerant may increase, and thus a volume of the refrigerant may increase. When a volume of the refrigerant inside the cylinder chamber 110 increases, a total amount of refrigerant that may be received in the cylinder chamber 110 may decrease. Therefore, there is a possibility that the volumetric efficiency and compression efficiency of the compression portion may be reduced.

According to the present disclosure, the bushing cover 400 may include a material having relatively low thermal conductivity, and thus it is possible to reduce a risk that frictional heat generated among the cylinder 100, the bushing 300, and the bushing cover 400 is transmitted to the cylinder chamber 110. Accordingly, the volumetric efficiency and compression efficiency of the compression portion may be improved.

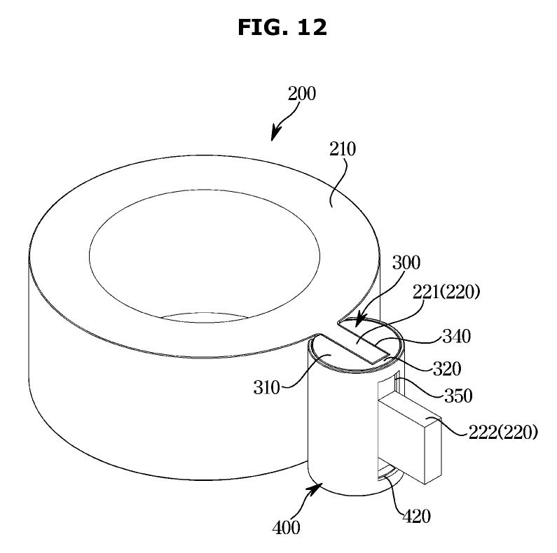

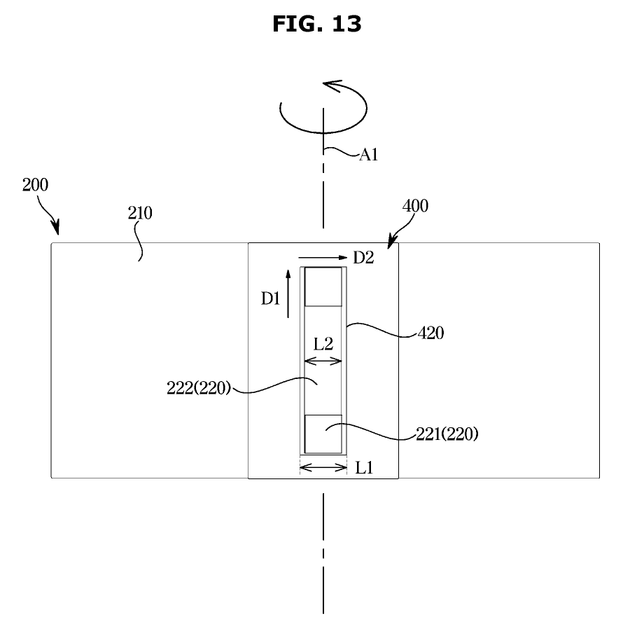

FIG. 12 is a perspective view illustrating a state in which a roller, a bushing, and the bushing cover are coupled according to one embodiment. FIG. 13 is a side view illustrating the state in which the roller, the bushing, and the bushing cover are coupled according to one embodiment.

Referring to FIGS. 11 to 13, the vane portion 220 of the roller 200 may be coupled to the bushing 300 and the bushing cover 400. For example, as the bushing 300 and the bushing cover 400 are first coupled to each other, and then the bushing 300 and the bushing cover 400 are simultaneously coupled to the vane portion 220, the vane portion 220 may be coupled to the bushing 300 and the bushing cover 400. However, the assembly method of the vane portion 220, the bushing 300, and the bushing cover 400 is not limited thereto.

The vane portion 220 may be provided to penetrate the bushing 300 and the bushing cover 400, respectively. Particularly, the second vane body 222 of the vane portion 220 may be provided to penetrate the bushing opening 350 of the bushing 300 and the cover opening 420 of the bushing cover 400, respectively. Accordingly, at least a portion of the second vane body 222 may be provided on the outside of the bushing 300.

The cover opening 350 may extend in a first direction D1 along which the rotation axis A2 of the bushing 300 and the bushing cover 400 extends. The cover opening 350 may extend in a second direction D2 intersecting the first direction D1. For example, the first direction D1 and the second direction D2 may be orthogonal to each other. For example, the shape of the cover opening 350 may be provided as a substantially rectangular shape.

As described above, the bushing 300 may rotate together with the vane portion 220. Particularly, the bushing 300 may rotate together with the vane portion 220 about the rotation axis A2. In addition, the bushing cover 400 may also rotate about the rotation axis A2. At this time, the rotation axis A2 may extend in the first direction D1, and the second direction D2 may intersect with the first direction D1. Accordingly, as the bushing 300, the vane portion 220, and the bushing cover 400 rotate about the rotation axis A2, the vane portion 220 and the cover opening 420 may move in the second direction D2.

As described above, the bushing cover 400 may rotate more slowly than the bushing 300. That is, the bushing cover 400 may rotate more slowly than the bushing 300 and the vane portion 220. Accordingly, a velocity at which the cover opening 420 moves along the second direction D2 as the bushing cover 400 rotates may be less than a velocity at which the vane portion 220 moves along the second direction D2 as the bushing 300 rotates.

According to the present disclosure, a length L1 in which the cover opening 420 is opened in the second direction D2 may be greater than a thickness L2 of one end of the vane portion 220. In other words, the length L1 in which the cover opening 420 is opened in the second direction D2 may be greater than the thickness L2 of the second vane body 222. With this configuration, the vane portion 220 may sufficiently rotate while penetrating the cover opening 420, and it is possible to prevent interference between the vane portion 220 and the bushing cover 400.

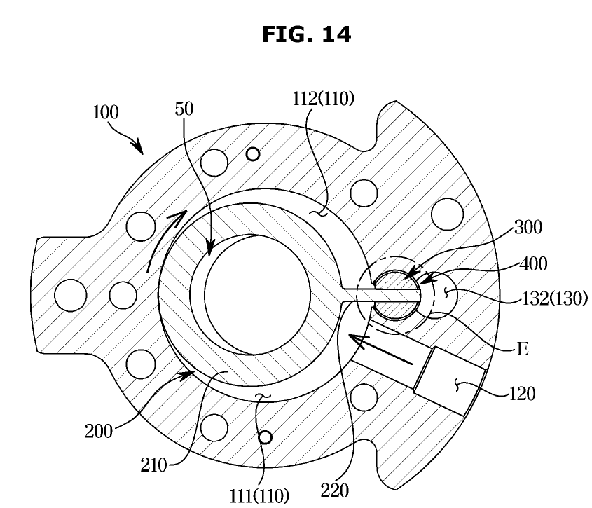

Hereinafter a compression process of the refrigerant by the roller body 210 and the accompanying movement and rotation method of the vane portion 220, and the rotation method of the bushing 300 and the bushing cover 400 will be described with reference to FIGS. 14 to 20.

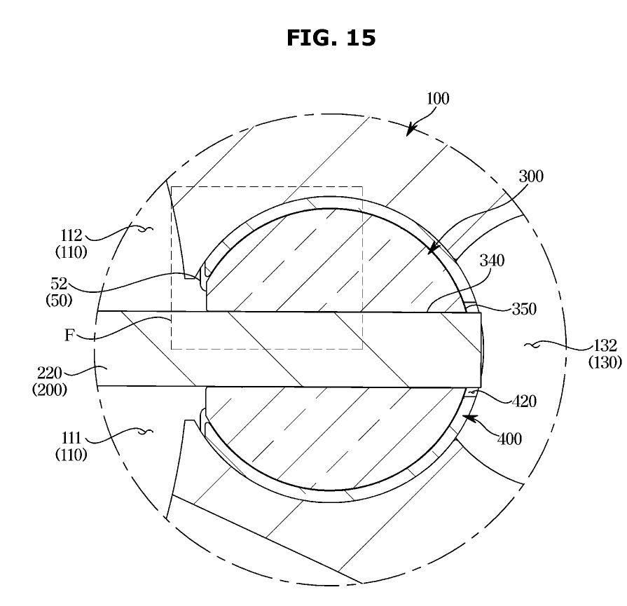

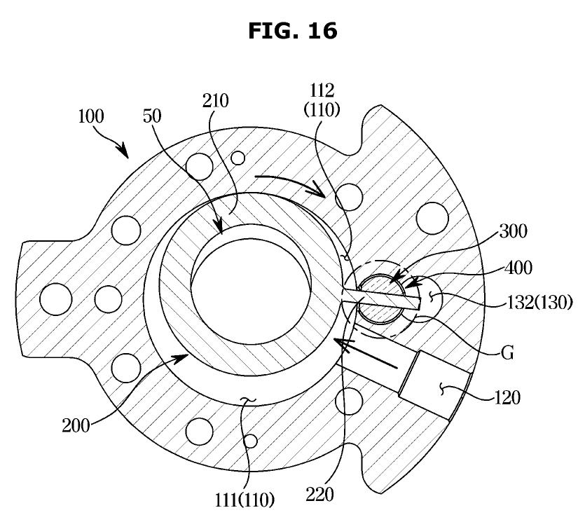

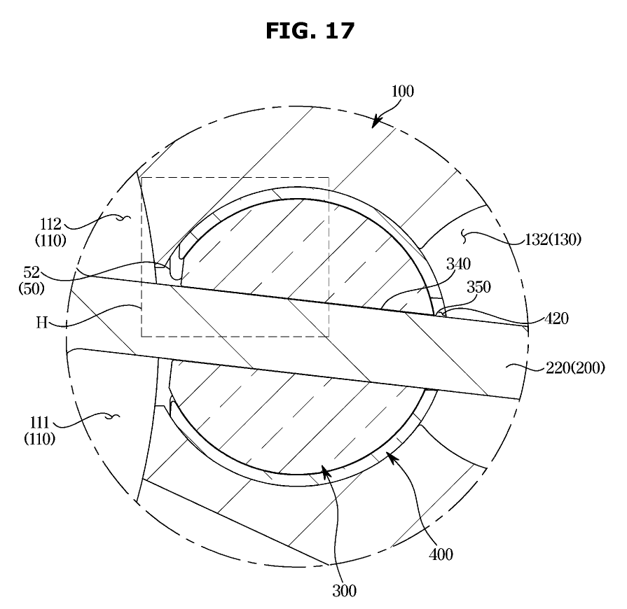

FIG. 14 is a cross-sectional view taken along line D-D' illustrated in FIG. 11. FIG. 15 is an enlarged view illustrating a region E illustrated in FIG. 14. FIG. 16 is a cross-sectional view illustrating a state in which the roller illustrated in FIG. 14 moves along an inner wall of a cylinder. FIG. 17 is an enlarged view of a region G illustrated in FIG. 16.

Referring to FIGS. 14 to 17, the refrigerant supplied to the cylinder 100 may be introduced into the cylinder chamber 110 through the inlet hole 120. Particularly, the refrigerant may be introduced into the inlet chamber 111.

Due to the pressure of the refrigerant introduced into the inlet chamber 111, the roller body 210 of the roller 200 may move along the inner surface of the cylinder 100. For example, referring to FIGS. 14 and 16, the roller body 210 may move clockwise along the inner surface of the cylinder 100.

As the roller body 210 moves along the inner surface of the cylinder 100, the refrigerant received in the compression chamber 112 may be compressed. When the pressure of the refrigerant compressed in the compression chamber 112 is greater than or equal to the predetermined level, the valve 700 may open the connecting hole 511 of the cylinder cover 500. Accordingly, the refrigerant compressed in the compression chamber 112 may be discharged to the outside of the cylinder 100 through the connecting hole 511 (refer to FIG. 6).

As the roller body 210 moves along the inner surface of the cylinder 100, the vane portion 220 may rotate and move. For example, the vane portion 220 may move in the radial direction of the roller body 210 while penetrating the bushing 300. For example, referring to FIGS. 15 and 17, the vane portion 220 may rotate clockwise together with the bushing 300.

The bushing cover 400 may rotate as the bushing 300 rotates. For example, referring to FIGS. 15 and 17, the bushing cover 400 may rotate clockwise together with the bushing 300.

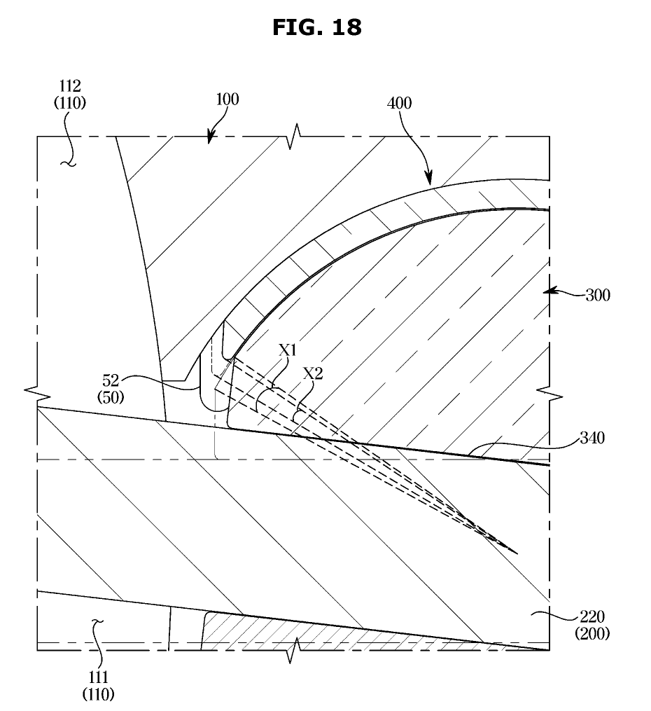

FIG. 18 is a view illustrating a state in which a region F illustrated in FIG. 15 and a region H illustrated in FIG. 17 are superimposed.

Referring to FIGS. 15, 17, and 18, as the roller body 210 moves along the inner surface of the cylinder 100, the bushing 300 and the bushing cover 400 may rotate together in a clockwise direction. For example, the bushing 300 may rotate by a first angle X1, and the bushing cover 400 may rotate by a second angle X2 less than the first angle X1.

As described above, the angular velocity of the bushing cover 400 may be less than the angular velocity of the bushing 300. That is, angular displacement that is formed as the bushing cover 400 rotates for a predetermined period of time may be smaller than angular displacement that is formed as the bushing 300 rotates for the same period of time. For example, the second angle X2 may be less than the first angle X1.

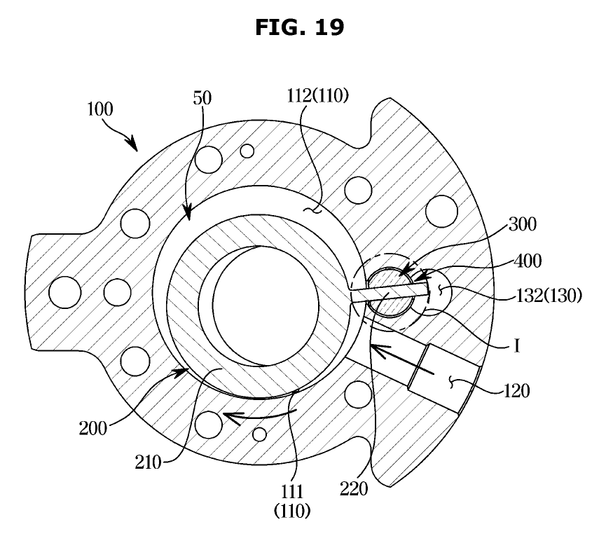

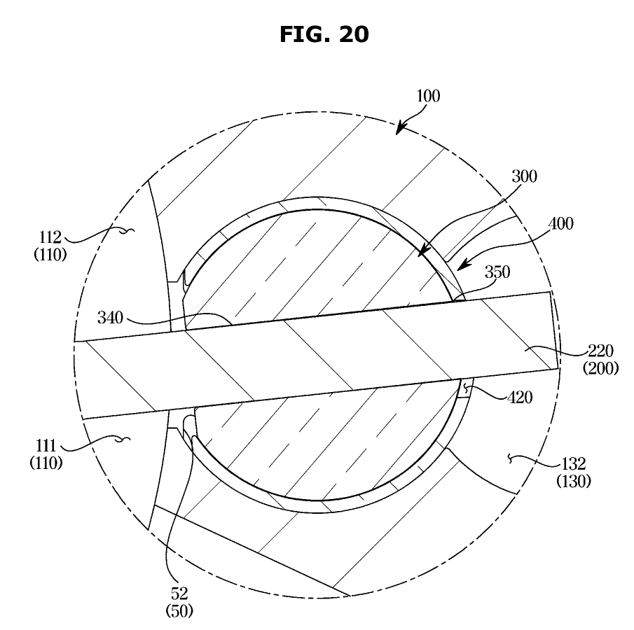

FIG. 19 is a cross-sectional view illustrating a state in which the roller illustrated in FIG. 16 moves along the inner wall of the cylinder. FIG. 20 is an enlarged view of a region I illustrated in FIG. 19.

Referring to FIGS. 16, 17, 19, and 20, the roller body 210 of the roller 200 may move along the inner surface of the cylinder 100 due to the pressure of the refrigerant flowing into the inlet chamber 111. For example, referring to FIGS. 16 and 19, the roller body 210 may move clockwise along the inner surface of the cylinder 100.

As the roller body 210 moves along the inner surface of the cylinder 100, the refrigerant received in the compression chamber 112 illustrated in FIG. 16 may be completely discharged through the connecting hole 511. Thereafter, the valve 700 may close the connecting hole 511 of the cylinder cover 500.

As the roller body 210 moves along the inner surface of the cylinder 100, the inlet chamber 111 illustrated in FIG. 16 may be converted into the compression chamber 112 illustrated in FIG. 19, and a new inlet chamber 111 illustrated in FIG. 19 may be formed again. The refrigerant supplied to the cylinder 100 may be introduced into the new inlet chamber 111, and thus the roller body 210 may continue to move along the inner surface of the cylinder 100.

As the roller body 210 moves along the inner surface of the cylinder 100, the vane portion 220 may rotate and move. For example, while penetrating the bushing 300, the vane portion 220 may move in the radial direction of the roller body 210 or in the direction opposite to the radial direction. For example, referring to FIGS. 17 and 20, the vane portion 220 may rotate counterclockwise together with the bushing 300.

The bushing cover 400 may rotate as the bushing 300 rotates. For example, referring to FIGS. 17 and 20, the bushing cover 400 may rotate clockwise together with the bushing 300. Even in this case, the angular velocity of the bushing cover 400 may be less than the angular velocity of the bushing 300.

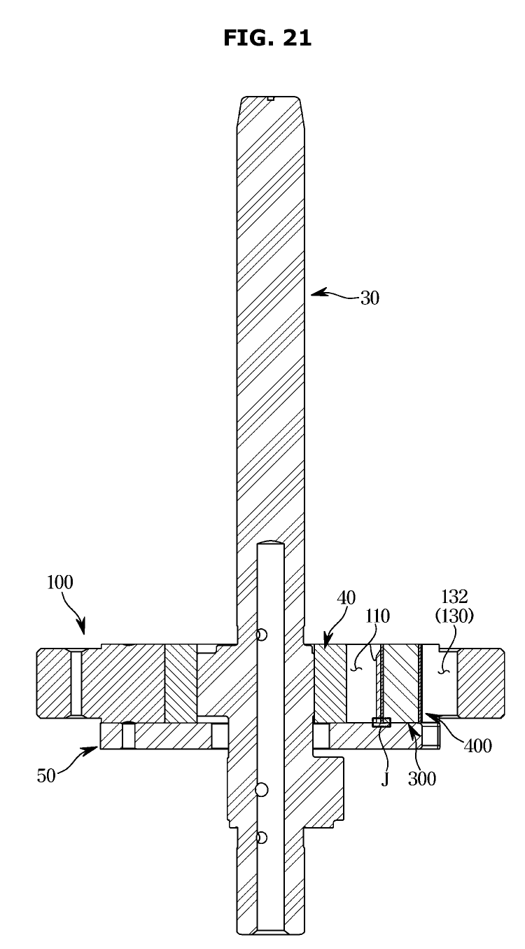

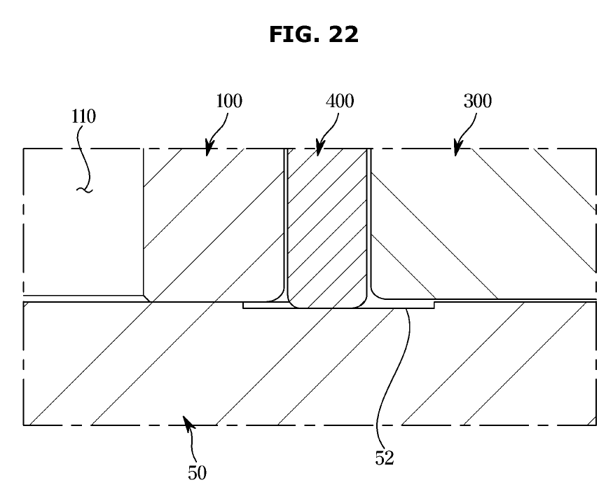

FIG. 21 is a cross-sectional view taken along line C-C' illustrated in FIG. 8. FIG. 22 is an enlarged view of a region J illustrated in FIG. 21.

Referring to FIGS. 21 and 22, the bushing cover 400 may be coupled to the mid-plate 50. Particularly, the bushing cover 400 may be rotatably coupled to the mid-plate 50.

At least a portion of the bushing cover 400 may be inserted into the cover insertion groove 52 of the mid-plate 50. For example, one end of the bushing cover 400 may be inserted into the cover insertion groove 52 of the mid-plate 50.

The cover insertion groove 52 may be formed by being recessed on one surface of the mid-plate 50. The cover insertion groove 52 may be formed at a position corresponding to the bushing cover 400.

Referring to FIGS. 4 and 5, the mid-plate 50 may include an upper cover insertion groove 52a and a lower cover insertion groove 52b.

The upper cover insertion groove 52a may be provided to allow at least a portion of the upper bushing cover 400a to be inserted thereinto. For example, the upper cover insertion groove 52a may be provided to allow a lower end of the upper bushing cover 400a to be inserted thereinto.

The upper cover insertion groove 52a may be formed on an upper surface of the mid-plate 50. The upper cover insertion groove 52a may be formed at a position corresponding to the upper bushing cover 400a.

The lower cover insertion groove 52b may be provided to allow at least a portion of the lower bushing cover 400b to be inserted thereinto. For example, the lower cover insertion groove 52b may be provided to allow an upper end of the lower bushing cover 400b to be inserted thereinto.

The lower cover insertion groove 52b may be formed on a lower surface of the mid-plate 50. The lower cover insertion groove 52b may be formed at a position corresponding to the lower bushing cover 400b.

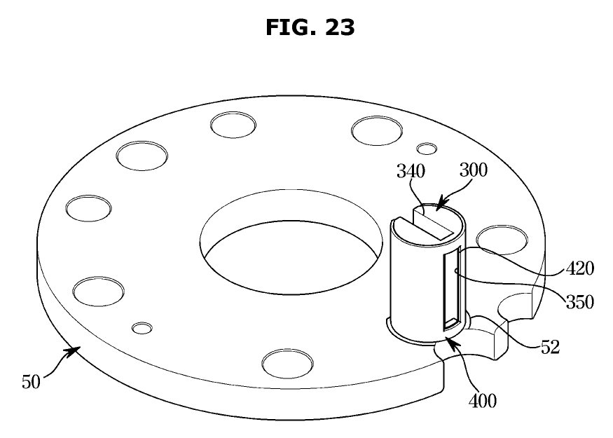

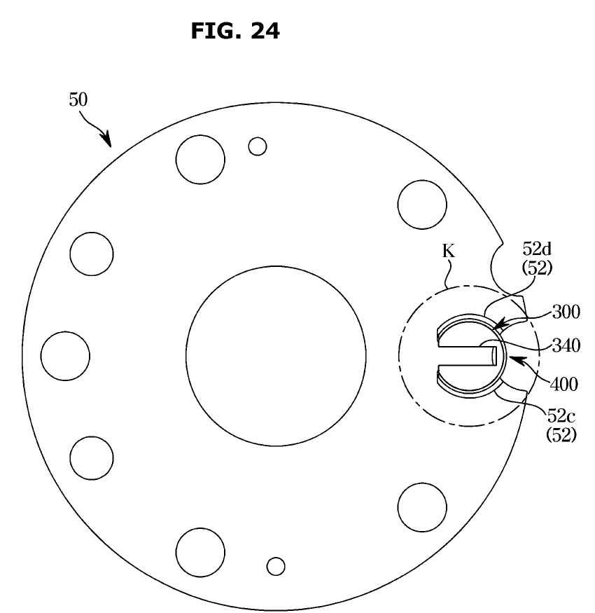

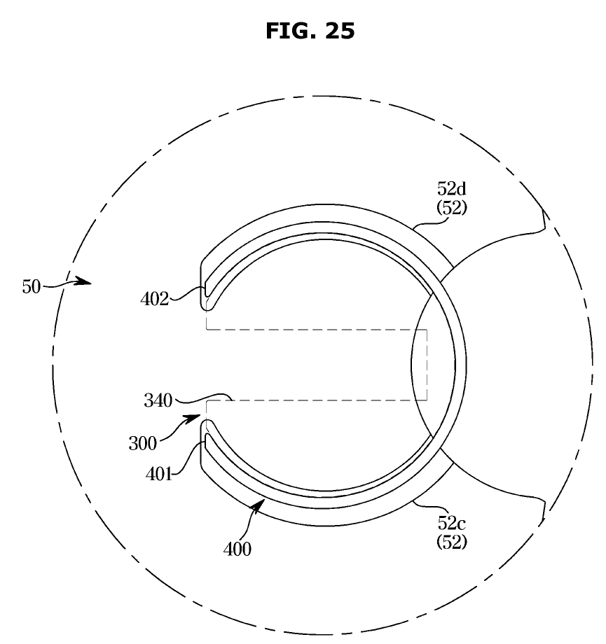

FIG. 23 is a perspective view illustrating a state in which a mid-plate, the bushing, and the bushing cover are coupled according to one embodiment. FIG. 24 is a plan view illustrating the state in which the mid-plate, the bushing, and the bushing cover are coupled according to one embodiment. FIG. 25 is an enlarged view of a region K illustrated in FIG. 24.

Referring to FIGS. 23 to 25, the cover insertion groove 52 may extend along the circumferential direction of the bushing 300. In other words, the cover insertion groove 52 may extend along a circumferential direction of the bushing cover 400. In other words, the bushing cover 400 may extend along the circumferential direction of the bushing 300, and the cover insertion groove 52 may extend along the direction in which the bushing cover 400 extends.

The bushing cover 400 may be configured to rotate while being inserted into the cover insertion groove 52. Particularly, the bushing cover 400 may rotate about the rotation axis A2 (refer to FIG. 11) while being inserted into the cover insertion groove 52.

The cover insertion groove 52 may be provided to limit the rotation of the bushing cover 400. In other words, the cover insertion groove 52 may be configured to prevent the bushing cover 400 from rotating at a predetermined angle or more.

Referring to FIG. 15, one end of the cover insertion groove 52 along the circumferential direction of the bushing 300 may be provided on the outside of the cylinder chamber 110. With this configuration, the cover insertion groove 52 may prevent at least a portion of the bushing cover 400 from being inserted into the cylinder chamber 110 caused by the rotation of the bushing cover 400. At this time, the cylinder chamber 110 may be a space formed by the inner surface of the cylinder 100 and the space may be distinguished from the cylinder groove 130.

When a portion of the bushing cover 400 is inserted into the cylinder chamber 110, there is a possibility that the roller body 210 moving along the inner wall of the cylinder 100 may collide with the bushing cover 400. When the roller body 210 collides with the bushing cover 400, significant damage may occur to each of the roller body 210 and the bushing cover 400.

According to the present disclosure, as one end of the cover insertion groove 52 along the circumferential direction of the bushing 300 is provided on the outside of the cylinder chamber 110, it is possible to prevent the occurrence of the damage due to collision between the roller body 210 and the bushing cover 400.

Referring to FIGS. 23 to 25, the cover insertion groove 52 may include a first insertion groove 52c and a second insertion groove 52d. The first insertion groove 52c may be provided to allow the one end 401 of the bushing cover 400 and a portion extending from the one end 401 to be inserted thereinto. The second insertion groove 52d may be provided to allow the other end 402 of the bushing cover 400 and a portion extending from the other end 402 to be inserted thereinto.

Each of the first insertion groove 52c and the second insertion groove 52d may extend along the circumferential direction of the bushing 300. Each of the first insertion groove 52c and the second insertion groove 52d may be provided to limit the rotation of the bushing cover 400. One end of the first insertion groove 52c and one end of the second insertion groove 52d along the circumferential direction of the bushing 300 may be provided on the outside of the cylinder chamber 110.

Although not shown in the drawing, the bushing cover 400 may also be rotatably coupled to the cylinder cover 500 (refer to FIGS. 4 and 5). In this case, the cylinder cover 500 may include a cover insertion groove into which at least a portion of the bushing cover 400 is inserted. For example, one end of the bushing cover 400 may be inserted into the cover insertion groove 52 of the mid-plate 50, and the other end provided on the opposite side of the one end of the bushing cover 400 may be inserted into the cover insertion groove of the cylinder cover 500.

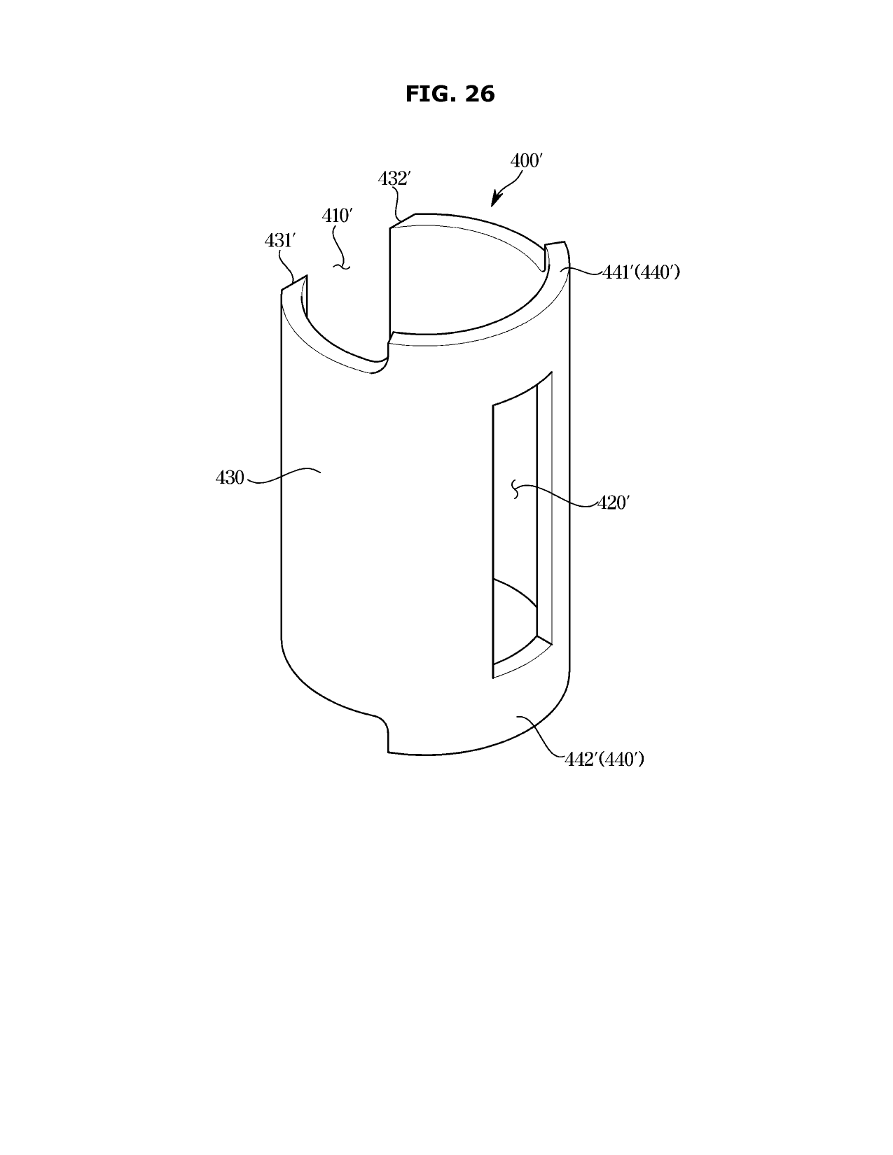

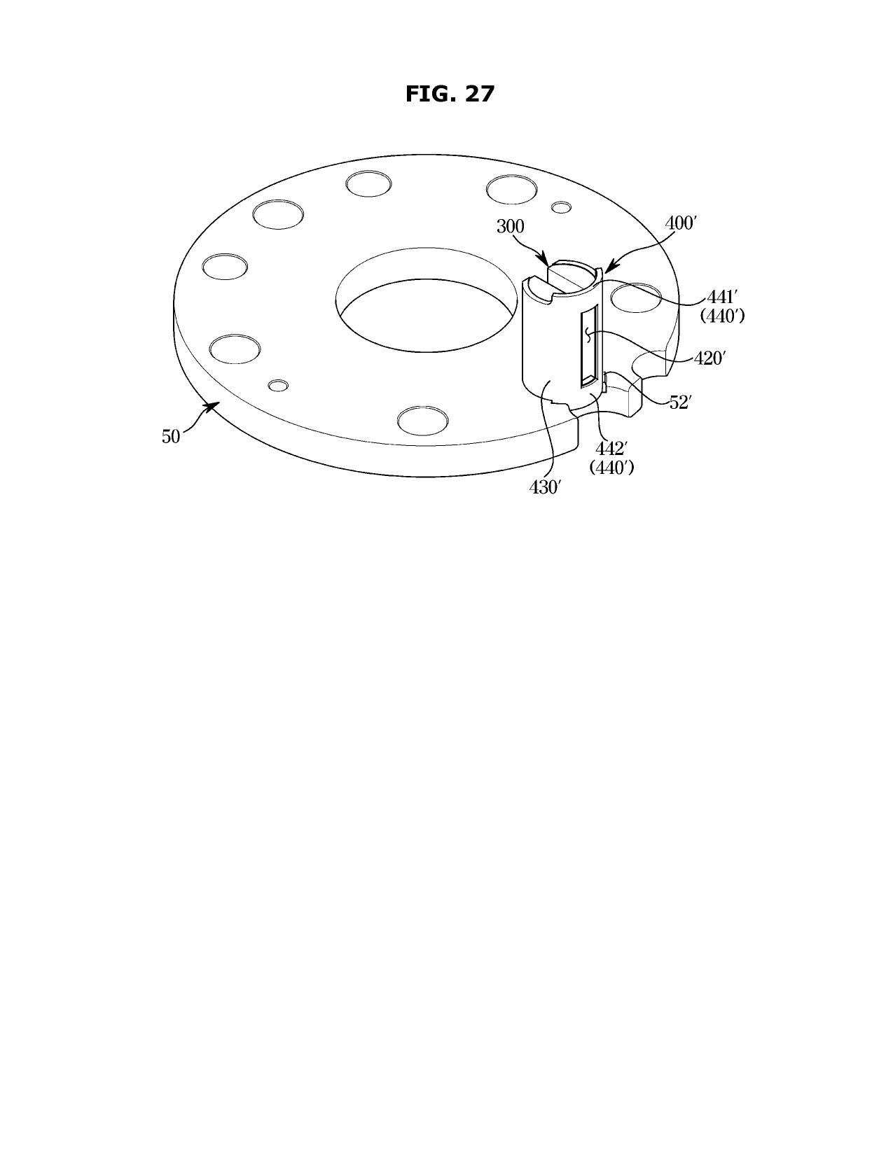

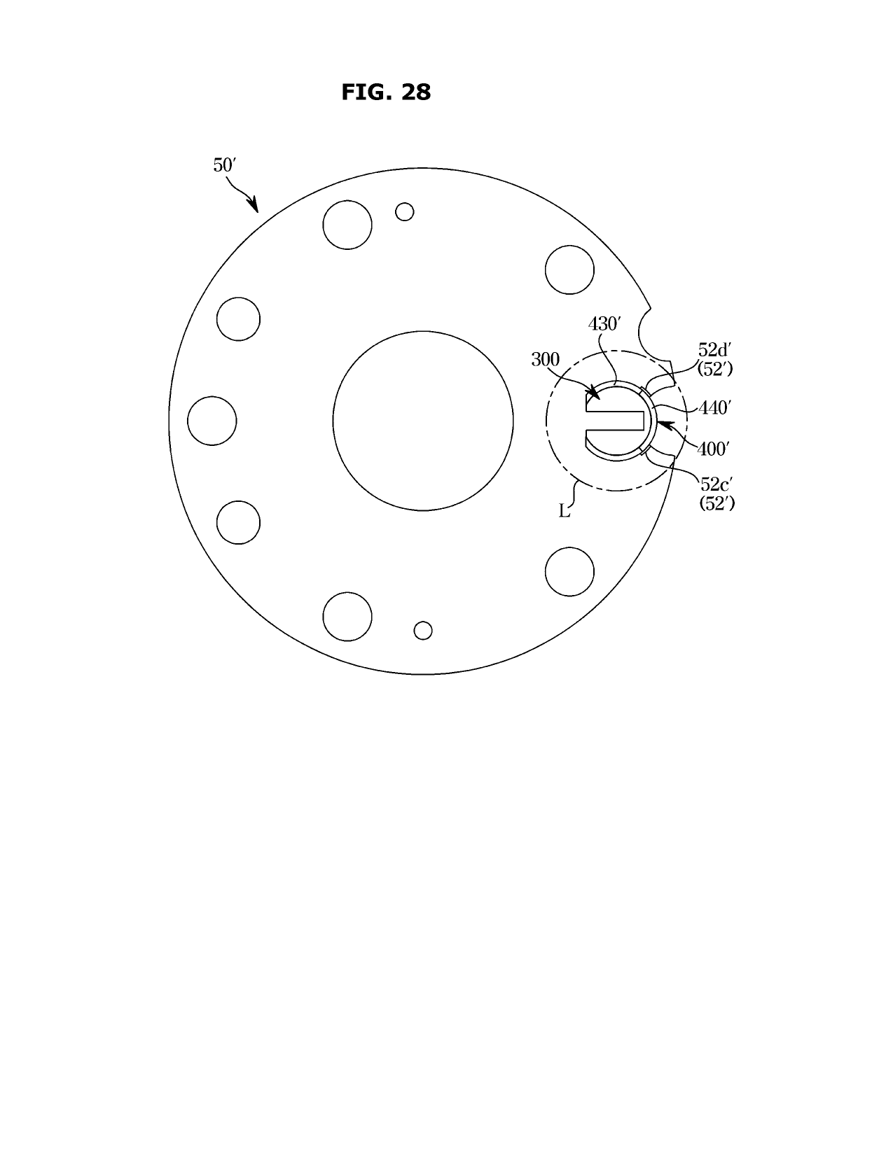

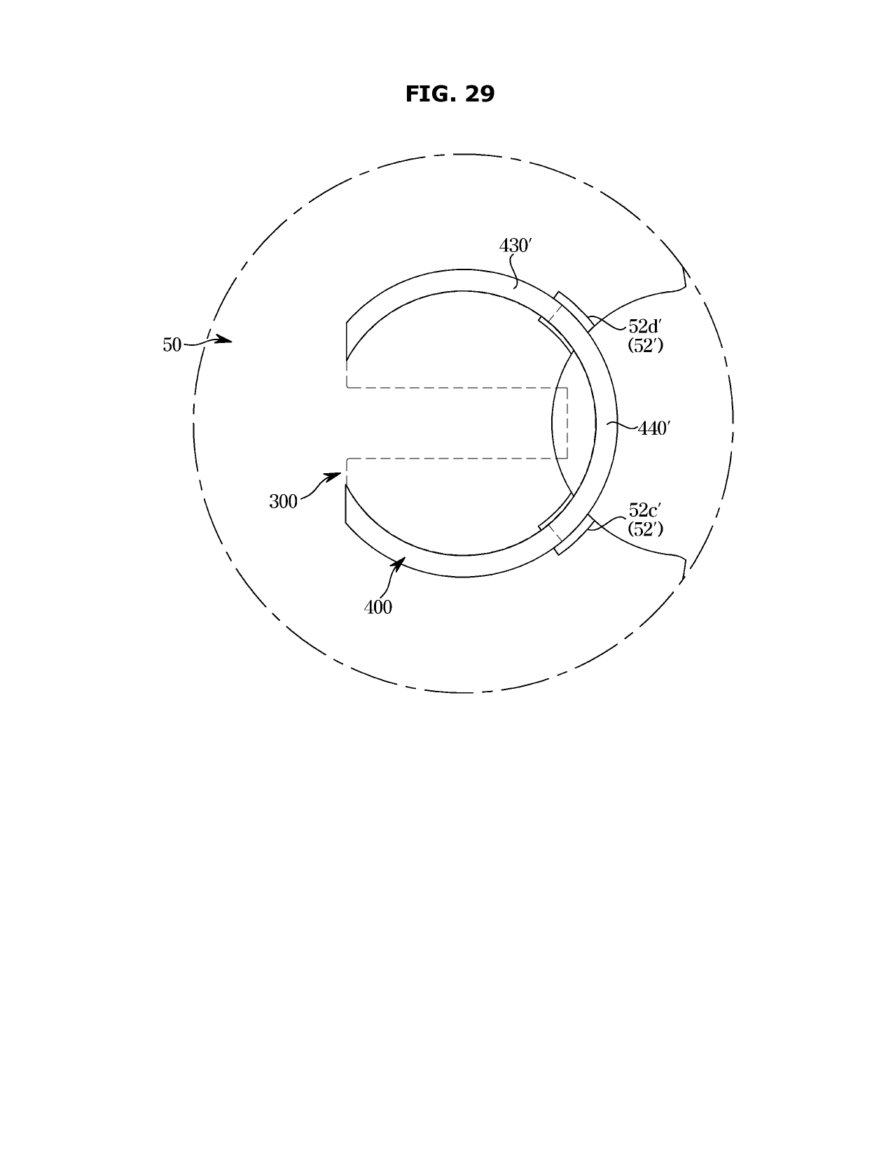

FIG. 26 is a perspective view illustrating a bushing cover according to one embodiment. FIG. 27 is a perspective view illustrating a state in which a mid-plate, a bushing, and the bushing cover are coupled according to one embodiment. FIG. 28 is a plan view illustrating the state in which the mid-plate, the bushing, and the bushing cover are coupled according to one embodiment. FIG. 29 is an enlarged view of a region L illustrated in FIG. 28.

Hereinafter a bushing cover 400' according to one embodiment of the present disclosure will be described with reference to FIGS. 26 to 29. In describing the bushing cover 400', components that are substantially the same as those illustrated in FIGS. 1 to 25 are assigned the same reference numerals, and a detailed description thereof may be omitted.

Referring to FIGS. 26 to 29, a compressor 1 may include the bushing cover 400'. At least a portion of the bushing cover 400' may cover a bushing 300. At least a portion of the bushing cover 400' may be configured to surround an outer surface of the bushing 300.

The bushing cover 400' may include a cover body 430'. The cover body 430' may cover the bushing 300. The cover body 430' may be provided to surround the outer surface of the bushing 300.

The bushing cover 400' may include an opening 410'. The opening 410' may be formed between one end 431' of the cover body 430' along a circumferential direction of the bushing 300 and the other end 432' of the cover body 430' provided on the opposite side of the one end 431' of the cover body 430'.

The bushing cover 400' may include a cover opening 420'. The cover opening 420' may be provided in the cover body 430'. The cover opening 420' may be provided on the opposite side of the opening 410'.

The bushing cover 400' may include a protrusion 440'. The protrusion 440' may protrude from the cover body 430'. Particularly, the protrusion 440' may protrude from the cover body 430' along a direction in which the rotation axis A2 (refer to FIG. 11) of the bushing 300 extends. In other words, the protrusion 440' may protrude from the cover body 430' along a direction in which the rotation axis of the bushing cover 400' extends.

The protrusion 440' may include a first protrusion 441' and a second protrusion 442'. The first protrusion 441' may protrude in one direction from the cover body 430', and the second protrusion 442' may protrude in a direction opposite to the one direction from the cover body 430'. For example, with reference to FIG. 26, the first protrusion 441' may protrude upward from the cover body 430', and the second protrusion 442' may protrude downward from the cover body 430'.

The protrusion 440' may protrude from a portion in which the cover opening 420' is provided. For example, each of the first protrusion 441' and the second protrusion 442' may protrude from the portion in which the cover opening 420' is provided. With this configuration, the cover opening 420' may be disposed between the first protrusion 441' and the second protrusion 442'.

According to the present disclosure, because the protrusion 440' is formed to protrude from the portion in which the cover opening 420' is provided, rigidity of the vicinity of the cover opening 420' may be increased. For example, referring to FIG. 26, because the first protrusion 441' is formed to protrude upward from the portion in which the cover opening 420' is provided, an upper portion of the cover opening 420' may be relatively thickened, and thus rigidity of the upper portion of the cover opening 420' may be increased. For example, referring to FIG. 26, because the second protrusion 442' is formed to protrude downward from the portion in which the cover opening 420' is provided, a lower portion of the cover opening 420' may be relatively thickened, and thus rigidity of the lower portion of the cover opening 420' may be increased. That is, rigidity of the bushing cover 400' may be increased through the above-described structure.

A corner formed between the cover body 430' and the protrusion 440' of the bushing cover 400' may be provided in a round shape. For example, each of corners formed between the cover body 430' and the first protrusion 441' and corners formed between the cover body 430' and the second protrusion 442' may be provided in a round shape. With this configuration, rigidity of the vicinity of the cover opening 420' may be increased. That is, with the above-described structure, rigidity of the bushing cover 400' may be increased.

The bushing cover 400' may be coupled to a mid-plate 50'. Particularly, the bushing cover 400' may be rotatably coupled to the mid-plate 50'.

At least a portion of the bushing cover 400' may be inserted into a cover insertion groove 52' of the mid-plate 50'. For example, one end of the bushing cover 400' may be inserted into the cover insertion groove 52' of the mid plate 50'.

Particularly, at least a portion of the second protrusion 442' may be inserted into the cover insertion groove 52' of the mid-plate 50'. For example, referring to FIG. 27, a lower end of the second protrusion 442' may be inserted into the cover insertion groove 52' of the mid-plate 50'.

The cover insertion groove 52' may be formed by being recessed on one surface of the mid-plate 50'. For example, referring to FIG. 27, the cover insertion groove 52' may be formed by being recessed on an upper surface of the mid-plate 50'. The cover insertion groove 52' may be formed at a position corresponding to the bushing cover 400'.

The cover insertion groove 52' may extend along the circumferential direction of the bushing 300. The bushing cover 400' may be configured to rotate while being inserted into the cover insertion groove 52'. The cover insertion groove 52' may be configured to limit the rotation of the bushing cover 400'.

The cover insertion groove 52' may include a first insertion groove 52c' and a second insertion groove 52d'. The first insertion groove 52c' may be provided to allow one end 4421' of the second protrusion 442' to be inserted thereinto. The second insertion groove 52d' may be provided to allow the other end 4421' of the second protrusion 442' to be inserted thereinto.

Each of the first insertion groove 52c' and the second insertion groove 52d' may extend along the circumferential direction of the bushing 300. Each of the first insertion groove 52c' and the second insertion groove 52d' may be provided to limit the rotation of the bushing cover 400'.

Particularly, each of the first insertion groove 52c' and the second insertion groove 52d' may limit the rotation of the bushing cover 400' by limiting the rotation of the second protrusion 442'. At this time, a length in which the second protrusion 442' extends along the circumferential direction of the bushing 300 may be less than a length in which the cover body 430' extends along the circumferential direction of the bushing 300. Accordingly, a length in which each of the first insertion groove 52c' and the second insertion groove 52d' extends along the circumferential direction of the bushing 300 may be relatively short. For example, the length of each of the first insertion groove 52c' and the second insertion groove 52d' extending along the circumferential direction of the bushing 300 may be less than the length of each of the first insertion groove 52c and the second insertion groove 52d extending along the circumferential direction of the bushing 300 illustrated in FIGS. 22 to 24.

Although not shown in the drawing, the bushing cover 400' may also be rotatably coupled to the cylinder cover 500 (refer to FIGS. 4 and 5). In this case, the cylinder cover 500 may include a cover insertion groove into which at least a portion of the first protrusion 441' is inserted.

According to the present disclosure, one embodiment in which the bushing cover 400' includes both the first protrusion 441' and the second protrusion 442' has been described. However, the bushing cover 400' does not necessarily have to include both the first protrusion 441' and the second protrusion 442'. For example, the bushing cover 400' may include only one of the first protrusion 441' and the second protrusion 442'.

A compressor 1 according to one embodiment may include a cylinder 100 including a chamber 110 therein; a roller 200 in the chamber 110 configured to compress a refrigerant received in the chamber 110, the roller including a roller body 210 movable in the chamber 110 along an inner surface of the cylinder 100 and a vane portion 220 extending from the roller body 210 toward the cylinder 100 and at least partially partitioning the chamber 110 to form an inlet chamber 111 into which the refrigerant is receivable and a compression chamber 112 in which the refrigerant is compressible, the vane portion 220 movable in a radial direction of the roller body 210 based on movement of the roller body 210; a bushing 300 in the cylinder 110 and rotatable relative to the cylinder 100, the bushing 300 covering at least a portion of the vane portion 220, and supporting movement of the vane portion 220 along the radial direction; and a bushing cover 400 or 400' surrounding an outer surface of the bushing 300 and rotatable along a rotation direction of the bushing 300.

The bushing cover 400 or 400' may extends along a circumferential direction of the bushing 300 between the cylinder 100 and the bushing 300.

The bushing cover 400 may include an opening 410 between a first end 401 of the bushing cover 400 and a second end 402 of the bushing cover 400 opposite the first end 401 along the circumferential direction, and configured to allow the vane portion 220 to pass therethrough.

The bushing 300 may be configured to rotate around a rotation axis A2 parallel to a central axis A1 of the roller body 210. The bushing cover 400 or 400' is rotatable around the rotation axis A2.

Each of the bushing 300 and the bushing cover 400 or 400' may configured to rotate as the roller body 210 moves along the inner surface.

With the roller body 210 moved along the inner surface, an angular velocity at which the bushing cover 400 or 400' rotates may be less than an angular velocity at which the bushing 300 rotates.

The compressor 1 may further include a plate 50 or 50' on a side of the cylinder 100 to form the chamber 110 together with the cylinder 100, the plate 50 or 50' including an insertion groove 52 or 52' into which at least a portion of the bushing cover 400 or 400' is inserted.

The insertion groove 52 or 52' may extend along the circumferential direction of the bushing 300.

The bushing cover 400 or 400' may be configured to rotate while being inserted into the insertion groove 52 or 52'. At least one end of the insertion groove 52 or 52' along the circumferential direction of the bushing 300 may be outside of the chamber 110.

The vane portion 220 may include a first vane body 221 that protrudes from the roller body 210 in the radial direction of the roller body 210 and is covered by the bushing 300; and a second vane body 222 that protrudes from the first vane body 221 in the radial direction and extends outside of the bushing 300. The bushing 300 may include a bushing opening 350 that allows the second vane body 222 to pass therethrough. The bushing cover 400 or 400' may include a cover opening 420 or 420' that allows the second vane body 222 to pass therethrough.

The cover opening 420 or 420' may extend along a first direction D1, in which the rotation axis A2 of the bushing cover 400 or 400' extends, and a second direction D2 intersecting the first direction D1. A length L1 of the cover opening 420 or 420' in the second direction D2 may be greater than a thickness L2 of the second vane body 222 in the second direction D2.

Oil is receivable between the cylinder 100 and the bushing cover 400 or 400' and between the bushing 300 and the bushing cover 400 or 400'.

A hardness of the bushing cover 400 or 400' may be greater than a hardness of the cylinder 100 and less than a hardness of the bushing 300.

The bushing cover 400' may further include a cover body 430' having the cover opening 420', and a protrusion 440' that protrudes from the cover body 430' in a direction in which the rotation axis A2 of the bushing 300 extends.

The compressor 1 may further include a plate 50' on a side of the cylinder 100 to form the chamber 110 together with the cylinder 100. The plate 50' may include an insertion groove 52' into which at least a portion of the protrusion 440' is inserted.

A compressor 1 according to one embodiment may include a cylinder 100 in which a cylinder chamber 110 is provided; a roller 200 configured to compress a refrigerant received in the cylinder chamber 110, the roller including a roller body 210 configured to move along an inner surface of the cylinder 100 in the cylinder chamber 110 and a vane portion 220 extending from the roller body 210 toward the cylinder 100 to partition the cylinder chamber 110; a bushing 300 rotatably coupled to the cylinder 100, provided to allow at least a portion of the vane portion 220 to be inserted thereinto, the bushing including a first cover portion 310 provided to cover one side surface of the vane portion 220, a second cover portion 320 provided to cover the other side surface 229 opposite to the one side surface 228 of the vane portion 220, and a connecting portion 330 provided to connect the first cover portion 310 and the second cover portion 320; and a bushing cover 400 or 400' disposed between the cylinder 100 and the bushing 300 and provided to surround an outer surface of each of the first cover portion 310, the second cover portion 320 and the connecting portion 330.

The bushing 300 may further include a bushing groove 340 formed by the first cover portion 310, the second cover portion 320 and the connecting portion 330, and a bushing opening 350 provided to allow one end of the vane portion 220 to pass therethrough and connected to the bushing groove 340. The bushing cover 400 or 400' may include a cover opening 420 or 420' provided to allow one end of the vane portion 220 to passe therethrough and formed in a position corresponding to the bushing opening 350.

The cover opening 420 or 420' may extend along a first direction D1, in which the rotation axis A2 of the bushing cover 400 or 400' extends, and a second direction D2 intersecting the first direction D1. A length L1, in which the cover opening 420 or 420' is open, may be greater than a thickness L2 of one end of the vane portion 220, based on the second direction D2.

A compressor 1 according to one embodiment may include a cylinder 100; a plate 50 or 50' provided on one side of the cylinder 100 and forming the cylinder chamber 110 together with the cylinder 100; a roller 200 configured to compress a refrigerant received in the cylinder chamber 110, the roller including a roller body 210 configured to move along an inner surface of the cylinder 100 in the cylinder chamber 110, and a vane portion 220 extending from the roller body 210 toward the cylinder 100 to partition the cylinder chamber 110; a bushing 300 rotatably coupled to the cylinder 100 and provided to cover at least a portion of the vane portion 220; and a bushing cover 400 or 400' provided to surround an outer surface of the bushing 300 and coupled to each of the cylinder 100 and the plate 50 or 50'.

The plate 50 or 50' may include an insertion groove 52 or 52' into which at least a portion of the bushing cover 400 or 400' is inserted.

As is apparent from the above description, a bushing cover may be provided on an outside of a bushing coupled to a vane. Accordingly, friction loss occurring in the bushing may be reduced.

Further, by reducing friction loss occurring in a bushing, compression efficiency of a compressor may be improved and a failure rate of the compressor may be reduced. In other words, performance and reliability of the compressor may be further improved.

Additional aspects of the disclosure will be set forth in part in the description which follows and, in part, will be obvious from the description, or may be learned by practice of the disclosure.

While the present disclosure has been particularly described with reference to exemplary embodiments, it should be understood by those of skilled in the art that various changes in form and details may be made without departing from the spirit and scope of the present disclosure.

1. A compressor comprising:
a cylinder including a chamber therein;
a roller in the chamber and configured to compress a refrigerant received in the chamber, the roller including:
a roller body movable in the chamber along an inner surface of the cylinder, and
a vane portion extending from the roller body toward the cylinder and at least partially partitioning the chamber to form an inlet chamber into which the refrigerant is receivable and a compression chamber in which the refrigerant is compressible, the vane portion movable in a radial direction of the roller body based on movement of the roller body;
a bushing in the cylinder and rotatable relative to the cylinder, the bushing covering at least a portion of the vane portion, and supporting movement of the vane portion along the radial direction; and
a bushing cover surrounding an outer surface of the bushing, and rotatable along a rotation direction of the bushing,
wherein the roller, the bushing, and the bushing cover are configured such that, with the roller body moved along the inner surface, the bushing supports movement of the vane portion in the radial direction and a size of the inlet chamber increases to move the refrigerant into the chamber and a size of the compression chamber decreases to compress the refrigerant moved into the chamber.

2. The compressor of claim 1, wherein
the bushing cover extends along a circumferential direction of the bushing between the cylinder and the bushing.

3. The compressor of claim 2, wherein
the bushing cover includes an opening between a first end of the bushing cover and a second end of the bushing cover opposite the first end along the circumferential direction, and configured to allow the vane portion to pass therethrough.

4. The compressor of claim 1, wherein
the bushing is rotatable around a rotation axis parallel to a central axis of the roller body, and
the bushing cover is rotatable around the rotation axis.

5. The compressor of claim 4, wherein
each of the bushing and the bushing cover is configured to rotate as the roller body moves along the inner surface.

6. The compressor of claim 5, wherein
with the roller body moved along the inner surface, an angular velocity at which the bushing cover rotates is less than an angular velocity at which the bushing rotates.

7. The compressor of claim 4, further comprising:
a plate on a side of the cylinder to form the chamber together with the cylinder, the plate including an insertion groove into which at least a portion of the bushing cover is inserted.

8. The compressor of claim 7, wherein
the insertion groove extends along a circumferential direction of the bushing.

9. The compressor of claim 8, wherein
the bushing cover is configured to rotate while being inserted into the insertion groove,
at least one end of the insertion groove along the circumferential direction of the bushing is outside of the chamber.

10. The compressor of claim 1, wherein
the vane portion includes:
a first vane body that protrudes from the roller body in the radial direction and is covered by the bushing, and
a second vane body that protrudes from the first vane body in the radial direction and extends outside of the bushing,
the bushing includes a bushing opening that allows the second vane body to pass therethrough, and
the bushing cover includes a cover opening that allows the second vane body to pass therethrough.

11. The compressor of claim 10, wherein
the cover opening extends along a first direction in which a rotation axis of the bushing cover extends and a second direction intersecting the first direction, and
a length of the cover opening in the second direction is greater than a thickness of the second vane body in the second direction.

12. The compressor of claim 1, wherein
oil is receivable between the cylinder and the bushing cover and between the bushing and the bushing cover.

13. The compressor of claim 1, wherein
a hardness of the bushing cover is greater than a hardness of the cylinder and less than a hardness of the bushing.

14. The compressor of claim 10, wherein
the bushing cover further includes:
a cover body having the cover opening, and
a protrusion that protrudes from the cover body in a direction in which a rotation axis of the bushing extends.

15. The compressor of claim 14, further comprising:
a plate on a side of the cylinder to form the chamber together with the cylinder,
wherein the plate includes an insertion groove into which at least a portion of the protrusion is inserted.
